(19) United States
(12) Patent Application Publication
(10) Pub. No.: US 2026/0254496 A1
(43) Pub. Date: Aug. 27, 2026

(54) TERMINAL, RADIO COMMUNICATION METHOD, AND BASE STATION

(71) Applicant: NTT DOCOMO, INC., Tokyo (JP)

(72) Inventors: Haruhi Echigo, Chiyoda-ku, Tokyo (JP); Hiroki Harada, Chiyoda-ku, Tokyo (JP); Yuki Matsumura, Chiyoda-ku, Tokyo (JP); Naoya Shibaike, Chiyoda-ku, Tokyo (JP); Liu Liu, Haidian District, Beijing (CN)

(73) Assignee: NTT DOCOMO, INC., Tokyo (JP)

(21) Appl. No.: 18/877,028

(22) PCT Filed: Jun. 30, 2022
(86) PCT No.: PCT/JP2022/026416

§ 371 Date: Dec. 19, 2024

(51) Int. Cl. H04B 7/06; H04B 17/318

(52) U.S. Cl. CPC H04B 7/0626; H04B 17/318

(57) ABSTRACT

A terminal according to an aspect of the present disclosure includes a control section that controls, based on a specific condition, switching between a first method in which a reference signal to be reported is included in a reference signal to be measured, and a second method in which the reference signal to be reported is not included in the reference signal to be measured, and a transmitting section that performs a channel state information report, based on the first method or the second method. According to an aspect of the present disclosure, preferable overhead reduction/channel estimation/resource use can be achieved.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP (registered trademark) ) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1:3GPP TS 36.300 V 8.12.0 “Evolved Universal Terrestrial Radio Access (E-UTRA) and Evolved Universal Terrestrial Radio Access Network (E-UTRAN) ; Overall description; Stage 2 (Release 8),” April, 2010

### SUMMARY OF INVENTION

### Technical Problem

For future radio communication technologies, it is studied to utilize the artificial intelligence (AI) technology, such as machine learning (ML), for control, management, and the like of networks/devices.

For example, channel state information (Channel State Information (CSI)) feedback capable of using beam prediction is under study.

However, definition of CSI in a case where the beam prediction is available has not been sufficiently studied. Unless these studies are sufficiently performed, appropriate overhead reduction/highly accurate channel estimation/highly efficient resource use cannot be achieved, which may suppress improvement of communication throughput/communication quality.

Thus, an object of the present disclosure is to provide a terminal, a radio communication method, and a base station capable of achieving preferable overhead reduction/channel estimation/resource use.

### Solution to Problem

A terminal according to an aspect of the present disclosure includes a control section that controls, based on a specific condition, switching between a first method in which a reference signal to be reported is included in a reference signal to be measured, and a second method in which the reference signal to be reported is not included in the reference signal to be measured, and a transmitting section that performs a channel state information report, based on the first method or the second method.

### Advantageous Effects of Invention

According to an aspect of the present disclosure, preferable overhead reduction/channel estimation/resource use can be achieved.

### BRIEF DESCRIPTION OF DRAWINGS

FIG. 1 is a diagram to show an example of a bit width of a CRI/SSBRI/L1-RSRP defined in Rel. 15/16.

FIG. 2 is a diagram to show an example of an AI model management framework.

FIG. 3 FIGS. 3A and 3B are diagrams to show examples of spatial-domain beam prediction and time-domain beam prediction, respectively.

FIG. 4 is a diagram to show an example of two-stage beam measurement.

FIG. 5 is a diagram to show an example of a CSI reference resource.

FIG. 6 FIGS. 6A and 6B are diagrams to show examples of a study of a timeline in a CSI report in two-stage beam measurement.

FIG. 7 is a diagram to show an example of beam prediction according to Embodiment 1-1.

FIG. 8 is a diagram to show an example of an RRC parameter according to Option 1-2-1.

FIG. 9 is a diagram to show an example of an RRC parameter according to Option 2-1-1.

FIG. 10 FIGS. 10A and 10B are diagrams to show examples of beam prediction according to Option 2-a and Option 2-b, respectively.

FIG. 11 FIGS. 11A and 11B are diagrams to show examples of a bit width of a field for a CRI/SSBRI/L1-RSRP according to Option 3-1 and Option 3-2, respectively.

FIG. 12 is a diagram to show an example of two-stage beam measurement according to Embodiment 4-1.

FIG. 13 is a diagram to show an example of an RRC parameter according to Option 4-2-1.

FIG. 14 is a diagram to show an example of a timeline according to a seventh embodiment.

FIG. 15 is a diagram to show correspondence between RS resources in variations of fourth to eighth embodiments.

FIG. 16 is a diagram to show an example of RS measurement/reporting according to Option 9-1-1.

FIG. 17 is a diagram to show an example of RS measurement/reporting according to Option 9-1-2.

FIG. 18 is a diagram to show an example of RS measurement/reporting according to Option 9-1-3.

FIG. 19 is a diagram to show an example of time-domain beam prediction.

FIG. 20 is a diagram to show an example of a schematic structure of a radio communication system according to one embodiment.

FIG. 21 is a diagram to show an example of a structure of a base station according to one embodiment.

FIG. 22 is a diagram to show an example of a structure of a user terminal according to one embodiment.

FIG. 23 is a diagram to show an example of a hardware structure of the base station and the user terminal according to one embodiment.

FIG. 24 is a diagram to show an example of a vehicle according to one embodiment.

### DESCRIPTION OF EMBODIMENTS

### (CSI Report (or Reporting))

In Rel-15/16 NR, a terminal (also referred to as a user terminal, a User Equipment (UE), and the like) generates (also referred to as determines, calculates, estimates, measures, and the like) channel state information (CSI), based on a reference signal (RS) (or a resource for the RS), and transmits (also referred to as reports, feeds back, and the like) the generated CSI to a network (for example, a base station). The CSI may be transmitted to the base station by using an uplink control channel (for example, a Physical Uplink Control Channel (PUCCH)) or an uplink shared channel (for example, Physical Uplink Shared Channel (PUSCH)), for example.

The RS used for the generation of the CSI may be at least one of a channel state information reference signal (CSI-RS), a synchronization signal/broadcast channel (Synchronization Signal/Physical Broadcast Channel (SS/PBCH)) block, a synchronization signal (SS), a demodulation reference signal (DMRS), and the like, for example.

The CSI-RS may include at least one of a non-zero power (NZP) CSI-RS and CSI-Interference Management (CSI-IM). The SS/PBCH block is a block including the SS and the PBCH (and a corresponding DMRS), and may be referred to as an SS block (SSB) or the like. The SS may include at least one of a primary synchronization signal (PSS) and a secondary synchronization signal (SSS).

Note that the CSI may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), L1-RSRP (reference signal received power in Layer 1 (Layer 1 Reference Signal Received Power)), L1-RSRQ (Reference Signal Received Quality), an L1-SINR (Signal to Interference plus Noise Ratio), an L1-SNR (Signal to Noise Ratio), and the like.

The UE may receive information related to a CSI report (report configuration information), and may control CSI reporting, based on the report configuration information. The report configuration information may be, for example, a radio resource control (RRC) information element (IE) “CSI-ReportConfig.” Note that, in the present disclosure, the RRC IE may be interchangeably interpreted as an RRC parameter, a higher layer parameter, and the like.

The report configuration information (for example, the RRC IE “CSI-ReportConfig”) may include at least one of the following, for example.
Information (report type information, for example, an REC IE “reportConfigType”) related to a type of the CSI report
Information (report quantity information, for example, an RRC IE “reportQuantity”) related to one or more quantities (one or more CSI parameters) of the CSI to be reported
Information (resource information, for example, an RRC IE “CSI-ResourceConfigId”) related to the resource for the RS used for generation of the quantity (the CSI parameter)
Information (frequency domain information, for example, an RRC IE “reportFreqConfiguration”) related to the frequency domain being a target of the CSI report For example, the report type information may indicate a periodic CSI (P-CSI) report, an aperiodic CSI (A-CSI) report, or a semi-persistent (semi-permanent) CSI (SP-CSI) report.

The report quantity information may indicate at least one combination of the above CSI parameters (for example, CRI, RI, PMI, CQI, LI, L1-RSRP, and the like).

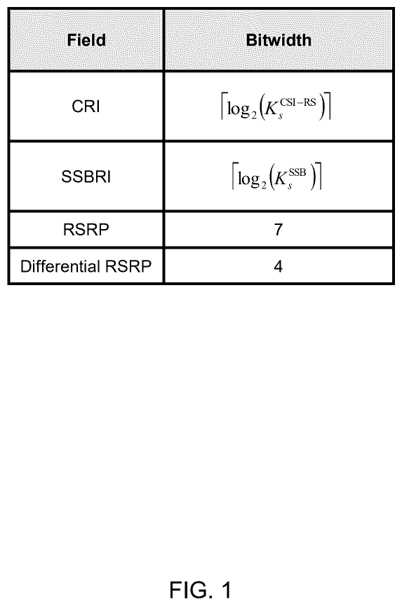

In Rel. 15/16, each CRI/SSBRI field is determined based on the number of CSI-RS resources or the number of SS/PBCH blocks in a resource set (see FIG. 1).

### (Application of Artificial Intelligence (AI) Technology to Radio Communication)

For future radio communication technologies, a study is underway to utilize the AI technology, such as machine learning (ML), for control, management, and the like of networks/devices.

For example, it is studied that a terminal (user terminal, User Equipment (UE))/base station (BS) utilizes the AI technology for improvement in channel state information (CSI) feedback (for example, overhead reduction, accuracy enhancement, prediction), enhancement in beam management (for example, accuracy enhancement, prediction in time/spatial domain), enhancement in location measurement (for example, location estimation/prediction enhancement), and the like.

An AI model may output at least one piece of information among an estimated value, a predicted value, a selected operation, classification, and the like, based on input information. The UE/BS may input channel state information, a reference signal measurement value, and the like to the AI model and output highly accurate channel state information/measured value/beam selection/location, future channel state information/radio link quality, and the like.

Note that, in the present disclosure, AI may be interpreted as an object (also referred to as a target, data, function, program, and the like) having (implementing) at least one of the following features:
estimation based on observed or collected information,
selection based on observed or collected information, and
prediction based on observed or collected information.

In the present disclosure, estimation, prediction, and inference may be interchangeably interpreted. In the present disclosure, “estimate,” “predict,” and “infer” may be interchangeably interpreted.

In the present disclosure, the object may be, for example, an apparatus, a device, or the like, such as a UE or a BS. In the present disclosure, the object may correspond to a program/model/entity operating in the apparatus.

Note that, in the present disclosure, the AI model may be interpreted as an object having (implementing) at least one of the following features:
feeding information to thereby generate an estimated value,
feeding information to thereby predict an estimated value,
feeding information to thereby find a feature, and
feeding information to thereby select an operation.

In the present disclosure, the AI model may mean a data-driven algorithm that applies the AI technology to generate an output set, based on an input set.

In the present disclosure, an AI model, a model, an ML model, predictive analytics, a predictive analytics model, a tool, an autoencoder, an encoder, a decoder, a neural network model, an AI algorithm, and the like may be interchangeably interpreted. The AI model may be derived by using at least one of regression analysis (for example, linear regression analysis, multiple regression analysis, logistic regression analysis), support vector machine, random forest, neural network, deep learning, and the like.

In the present disclosure, the autoencoder may be interchangeably interpreted as an arbitrary autoencoder such as a stacked autoencoder and a convolutional autoencoder. The encoder/decoder in the present disclosure may adopt a model of Residual Network (ResNet), DenseNet, RefineNet, or the like.

In the present disclosure, an encoder, encoding, encode/encoded, modification/change/control using an encoder, compressing, compress/compressed, generating, generate/generated, and the like may be interchangeably interpreted.

In the present disclosure, a decoder, decoding, decode/decoded, modification/change/control using a decoder, decompressing, decompress/decompressed, reconstructing, reconstruct/reconstructed, and the like may be interchangeably interpreted.

In the present disclosure, a layer (for an AI model) may be interchangeably interpreted as a layer (input layer, intermediate layer, or the like) used in an AI model. The layer in the present disclosure may correspond to at least one of an input layer, an intermediated layer, an output layer, a batch normalization layer, a convolutional layer, an activation layer, a dense layer, a normalization layer, a pooling layer, an attention layer, a dropout layer, a fully-connected layer, and the like.

In the present disclosure, examples of a method for training the AI model may include supervised learning, unsupervised learning, reinforcement learning, and federated learning. The supervised learning may mean processing for training a model, based on input and a corresponding label. The unsupervised learning may mean processing for training a model without labeled data. The reinforcement learning may mean processing for training a model in an environment where models interact with each other, based on an input (in other words, a state) and a feedback signal (in other words, compensation) generated from an output of the model (in other words, action).

In the present disclosure, generation, computation, derivation, and the like may be interchangeably interpreted. In the present disclosure, “perform,” “manage,” “operate,” “carry out,” and the like may be interchangeably interpreted. In the present disclosure, training, learning, update, retraining, and the like may be interchangeably interpreted. In the present disclosure, inference, after-training, substantial use, actual use, and the like may be interchangeably interpreted. In the present disclosure, a signal and a signal/channel may be interchangeably interpreted.

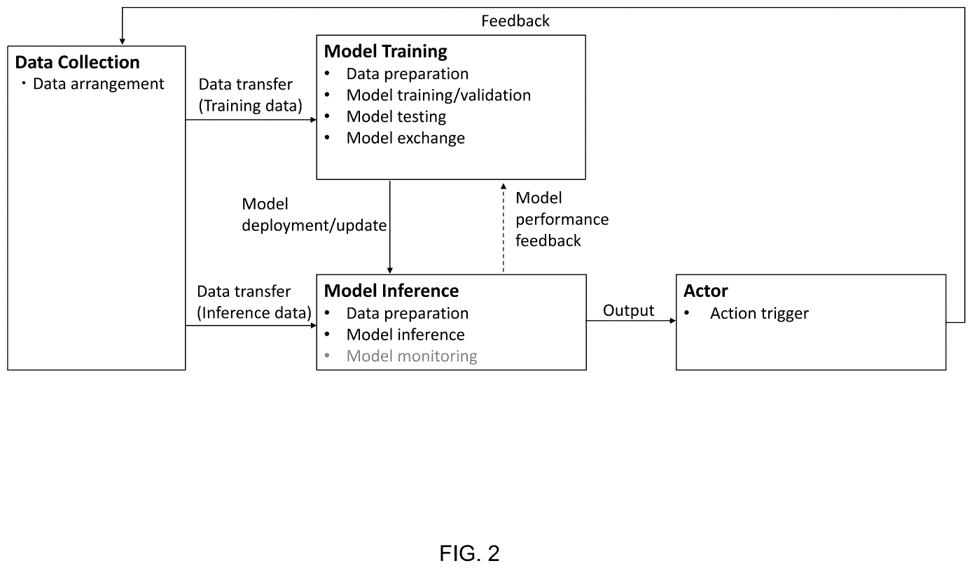

FIG. 2 is a diagram to show an example of an AI model management framework. In the present example, stages related to an AI model are shown using blocks. The present example is also expressed as AI model life cycle management.

A data collection stage corresponds to a stage to collect data for generating/updating the AI model. The data collection stage may include data arrangement (for example, determining which data is forwarded for model training/model inference), data forwarding (for example, forwarding data to an entity (for example, UE, gNB) performing model training/model inference), and the like.

Note that the data collection may mean processing in which data is collected by a network node, a management entity, or a UE for the purpose of AI model training/data analysis/inference. In the present disclosure, the processing and procedure may be interchangeably interpreted.

A model training stage is to perform the model training, based on data (training data) forwarded from the collection stage. This stage may include data preparation (for example, performing pre-processing, cleaning, formatting, conversion, and the like of data), model training/validation, model testing (for example, checking whether a trained model meets a performance threshold), model exchange (for example, forwarding a model for distributed learning), model deployment/update (deploying/updating a model for an entity performing model inference), and the like.

Note that the AI model training may mean processing for training an AI model with a data-driven method and acquiring a trained AI model for inference.

AI model validation may mean sub-processing for training for evaluating quality of an AI model by using a dataset different from a dataset used for the model training. The sub-processing is useful for selection of a model parameter for generalization beyond the data set used for the model training.

AI model testing may mean sub-processing for training for evaluating performance of a final AI model by using a dataset different from the dataset used for the model training/validation. Note that, unlike the validation, the testing may not be based on subsequent model tuning.

A model inference stage is to perform model inference, based on the data (inference data) forwarded from the collection stage. This stage may include data preparation (for example, performing pre-processing, cleaning, formatting, conversion, and the like of data), model inference, model monitoring (for example, monitoring model inference performance), model performance feedback (feeding back model performance to an entity performing model training), output (providing a model output to an actor), and the like.

Note that AI model inference may mean processing for generating an output set from an input set by using a trained AI model.

A UE-side model may mean an AI model in which the inference is completely performed in a UE. A network-side model may mean an AI model in which the inference is completely performed in a network (for example, a gNB).

A one-sided model may mean a UE-side model or a network-side model. A two-sided model may mean a pair of AI models in which joint inference is performed. Here, the joint inference may include AI inference in which the inference is performed jointly over the UE and the network, and, for example, a first part of the inference may be performed first by the UE and the remaining part may be performed by the gNB (or vice versa).

AI model monitoring may mean processing for monitoring inference performance of an AI model, and may be interchangeably interpreted as model performance monitoring, performance monitoring, and the like.

Note that model registration may mean that a model is given a version identifier and is made executable by being compiled into specific hardware used in an inference stage. Model deployment may mean distributing a runtime image (or execution environment image) of a fully developed and tested model to a target (for example, a UE/gNB) in which inference is performed (or enabling the runtime image in the target).

An actor stage may include an action trigger (for example, determining whether to trigger action to another entity), feedback (for example, feeding back information required for training data/inference data/performance feedback), and the like.

Note that, for example, training of a model for mobility optimization may be performed in, for example, maintenance, operation, and administration in a network (NW) (Operation, Administration and Maintenance (Management) (OAM))/gNodeB (gNB). In the former case, interoperation, large amounts of storage, operator manageability, model flexibility (such as feature engineering) are advantageous. In the latter case, model update latency, data exchange for model deployment, and the like are advantageously not required. The inference of the model described above may be performed in the gNB, for example.

An entity performing training/inference may differ depending on a use case (in other words, an AI model function). The AI model function may include beam management, beam prediction, an autoencoder (or information compression), location positioning, and the like.

For example, for AI-aided beam management based on a measurement report, the OAM/gNB may perform the model training, and the gNB may perform the model inference.

For AI-aided UE-assisted positioning, a Location Management Function (LMF) may perform the model training, and the LMF may perform the model inference.

For CSI feedback/channel estimation using an autoencoder, the OAM/gNB/UE may perform the model training, and the gNB/UE may perform the model inference (jointly).

For AI-aided beam management or AI-aided UE-based positioning based on beam measurements, the OAM/gNB/UE may perform the model training, and the UE may perform the model inference.

Note that model activation may mean enabling of an AI model for a specific function. Model deactivation may mean disabling of an AI model for a specific function. Model switching may mean that a currently active AI model for a specific function is deactivated and a different AI model can be activated.

Model transfer may mean distribution of an AI model over an air interface. This distribution may include distribution, on a reception side, of one or both of a known model structure parameter and a new model with a parameter. This distribution may include a complete model or a partial model. A model download may mean model transfer from a network to a UE. A model upload may mean model transfer from a UE to a network.

### (Beam Prediction in Beam Management)

For future radio communication systems (for example, Rel. 18 (or later versions)), introduction of beam management with beam prediction is under study.

As the beam prediction, spatial-domain beam prediction, time-domain (temporal) beam prediction, and a combination of the spatial-domain beam prediction and the time-domain beam prediction are under study.

The spatial-domain beam prediction and the time-domain (temporal) beam prediction may be performed in at least one of a UE and a base station.

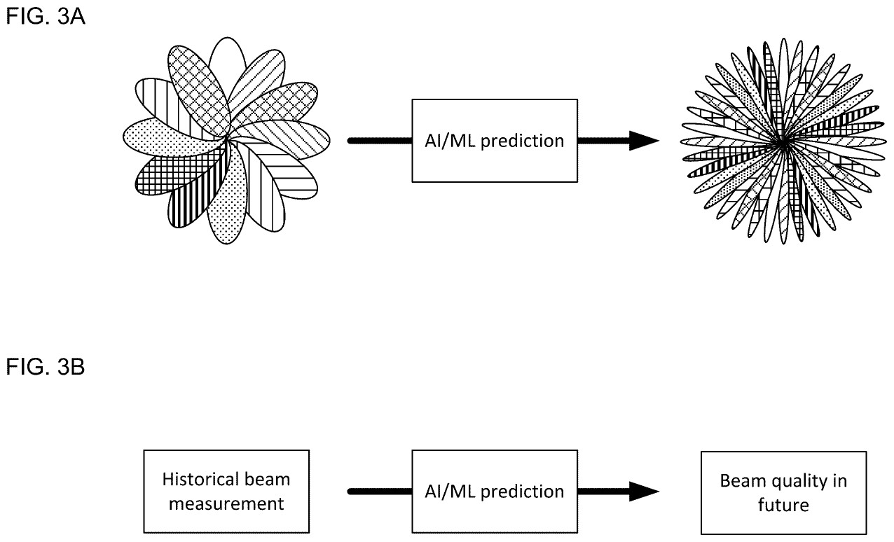

In the spatial-domain beam prediction, the UE/base station may input, to an AI model, a measurement result (beam quality, for example, RSRP) based on a sparse (or thick/broad) beam to output dense (or thin/narrow) beam quality (see FIG. 3A).

In the time-domain (temporal) beam prediction, the UE/BS may

input, to an AI model, a time-series (past, current, or the like) measurement result (beam quality, for example, RSRP) to output future beam quality (see FIG. 3B).

In the present disclosure, the sparse (or thick/broad) beam may mean a beam (pattern) that is sparsely distributed in a spatial/angle domain. The dense (or thin/narrow) beam may mean a beam (pattern) that is densely distributed in a spatial/angle domain.

### (Two-stage/step Beam Measurement)

For future radio communication systems (for example, Rel. 18 (or later versions)), it is studied that two-stage/step beam measurement is introduced in beam management.

In beam measurement using one-stage beam prediction, measurement of beams/RSs in a certain set (which may be referred to as set B) may be performed and prediction of beams/RSs in another set (which may be referred to as set A) may be performed.

CRIS/SSBRIs corresponding to the top N beams (N is a specific positive integer) from among the predicted beams and predicted to have good qualities, and beam qualities (for example, L1-RSRPs/L1-SINRs) corresponding to the CRIS/SSBRIs may be reported.

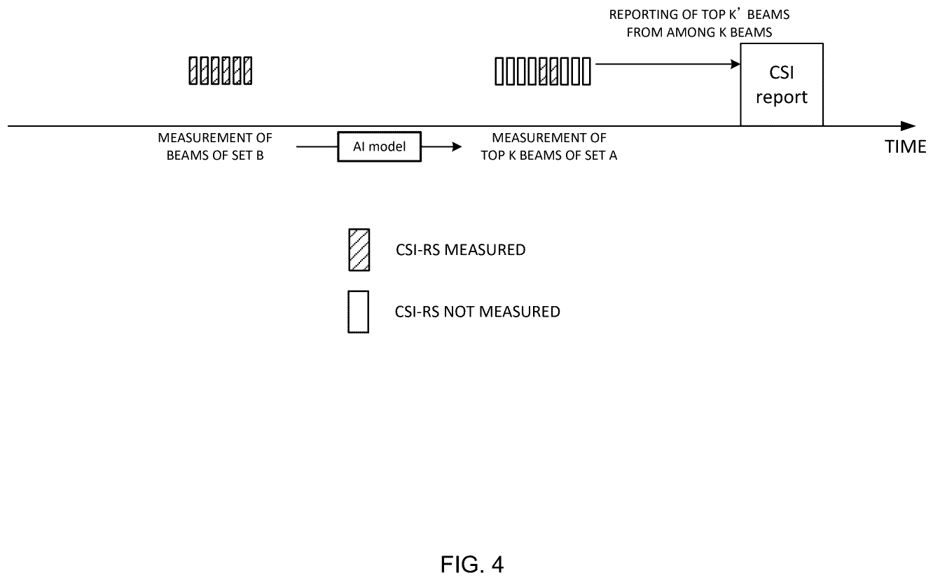

Two-stage beam prediction will be described by using FIG. 4.

In beam measurement using two-stage beam prediction, firstly, measurement of beams/RSs in a certain set (which may be referred to as set B) may be performed and prediction of beams/RSs in another set (which may be referred to as set A) may be performed.

Subsequently, the top K beams/RSs (K is a specific positive integer) predicted to have good qualities, from among the predicted beams, may be measured.

Furthermore, CRIS/SSBRIs having good qualities and corresponding to the top K′ beams/RSs (K′ is a specific positive integer) from among the K measured beams/RSs, and beam qualities (for example, L1-RSRPs/L1-SINRs) corresponding to the CRIS/SSBRIS may be reported.

Note that, in the present disclosure, the first measurement of the beams/RSs may be referred to as first measurement or measurement in a first stage/step. In the present disclosure, the measurement of the beams/RSs subsequent to the first measurement may be referred to as second measurement or measurement in a second stage/step.

### (CSI Reference Resource)

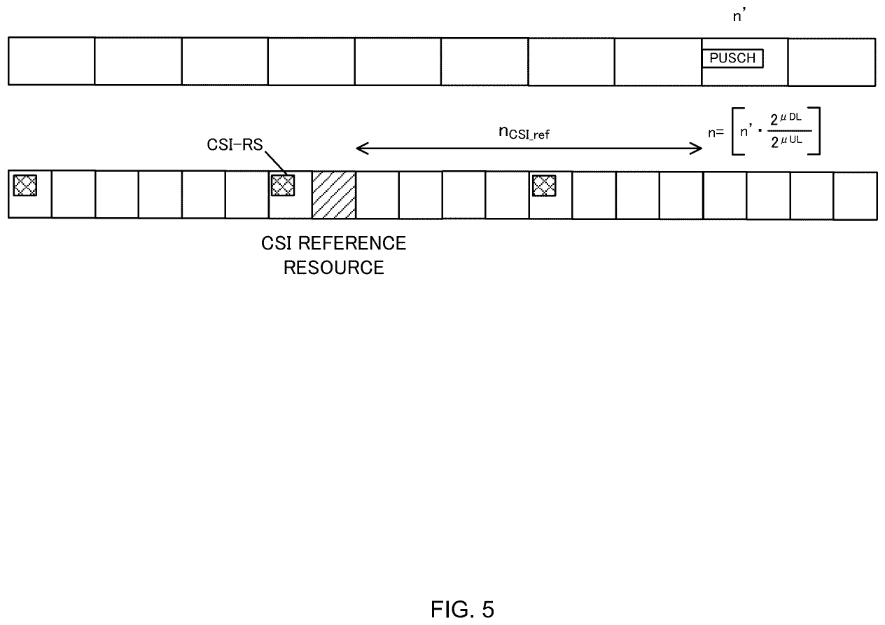

A CSI reference resource in Rel. 17 will be described. A CSI reference resource of a serving cell is defined as follows (the reference resource is shown in FIG. 5):
in the frequency domain, a band with which derivative CSI is associated, and
in the time domain, a single DL slot n-n_{CSI_ref}. Note that it is assumed that a CSI report is transmitted in a UL slot n′. The relationship between n and n′ is as shown in FIG. 5. In other words, n is a DL slot corresponding to the UL slot n′ in which the CSI report is transmitted.

In cases of periodic CSI and semi-persistent CSI reports, n_{CSI_ref} is a minimum value (4·2^{μDL} or greater for a single CSI-RS/SSB DL slot, 5·2^{μDL} or greater for a plurality of CSI-RS/SSB DL slots) corresponding to an enabled DL slot.

In a case of an aperiodic CSI report, it is assumed that n_{CSI_ref} is a minimum value ({Z′/N_{symb}^{slot}} or greater) corresponding to an enabled DL slot. The UE is indicated by DCI to report CSI in the same slot as that for a CSI request, and thus n_{CSI_ref} corresponds to the same slot as that for the CSI request.

### (Time Restriction for CSI Resource and CSI Report)

For the above-described two-stage beam measurement, restriction on a timeline with consideration of time for beam measurement/prediction in the UE/base station is under study.

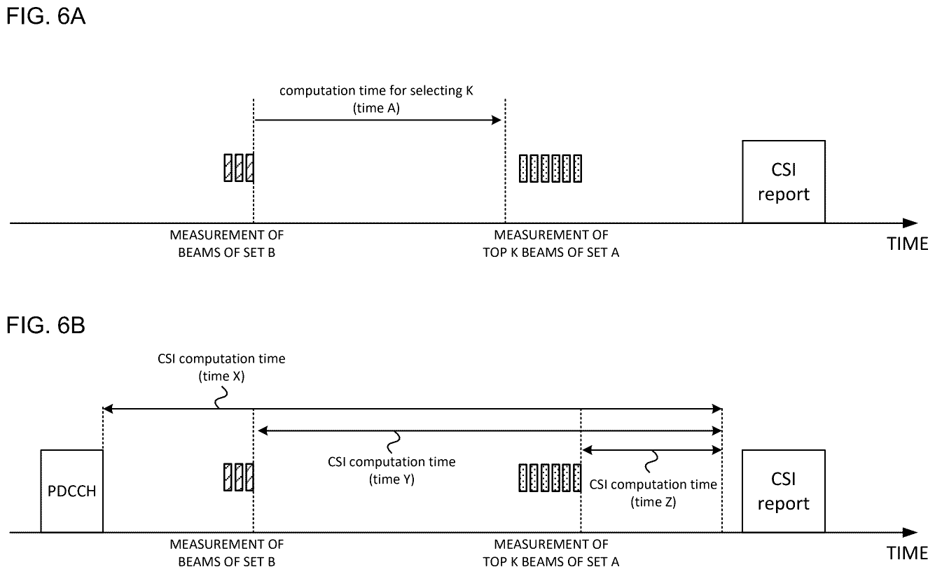

FIG. 6A is a diagram to show an example of the study of the timeline in the periodic/semi-persistent CSI report in the two-stage beam measurement.

The example shown in FIG. 6A describes time A as the lowest time from a last symbol for reception of set B until measurement of the top K beams in set A.

This time A may correspond to computation time for selecting/determining K beams.

FIG. 6B is a diagram to show an example of the study of the timeline in the aperiodic CSI report in the two-stage beam measurement.

In the example shown in FIG. 6B describes the lowest time from a last symbol for a PDCCH for triggering a CSI report until a start of the CSI report (CSI computation time X), the lowest time from a last symbol for reception of set B until the start of the CSI report (CSI computation time Y), and the lowest time from a last symbol for measurement of the top K beams in set A until the start of the CSI report (CSI computation time Z).

Incidentally, if the same framework (such as bit width) as that for an existing L1-RSRP/SINR (defined in Rel. 15/16) is reused for a predicted L1-RSRP/SINR, it is conceivable that a resource of an RS (CSI-RS and SSB) corresponding to set A is required to be included in a resource set for reporting of “ssb-Index-RSRP.” However, a configuration of a CSI report for the predicted L1-RSRP/SINR has not been sufficiently studied.

In an existing specification, the UE measures L1-RSRPs/SINRs of resources of CSI-RSs/SSBs in the same CSI resource configuration (CSI-ResourceConfig), and reports the measured L1-RSRPs/SINRs. On the other hand, in spatial-domain beam prediction, a resource to be measured and an RS resource associated with a reported L1-RSRP/SINR are not always the same. For such a case, how to determine an RS to be measured and an RS to be reported has not been sufficiently studied.

The time restriction for the CSI resource and the CSI report in the two-stage beam measurement described above has not also been sufficiently studied.

Accordingly, unless a study is sufficiently made on definition of CSI in a case where beam prediction is available, appropriate overhead reduction/highly accurate channel estimation/highly efficient resource use cannot be achieved, which may suppress improvement of communication throughput/communication quality.

Hence, the inventors of the present invention came up with the idea of a preferable CSI feedback method. Note that each of the embodiments of the present disclosure may be applied when AI/prediction is not used.

Embodiments according to the present disclosure will be described in detail with reference to the drawings as follows.

The radio communication methods according to respective embodiments may each be employed individually, or may be employed in combination.

In the present disclosure, “A/B” and “at least one of A and B” may be interchangeably interpreted. In the present disclosure, “A/B/C” may refer to “at least one of A, B, and C.”

In the present disclosure, “activate,” “deactivate,” “indicate,” “select,” “configure,” “update,” “determine,” and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, a field, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or o the like. The broadcast information may be, for example, a master information block (MIB), a system information block (SIB), minimum system information (Remaining Minimum System Information (RMSI)), other system information (OSI), or the like.

In the present disclosure, physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, a CSI-RS, a non zero power (NZP) CSI-RS, a zero power (ZP) CSI-RS, and CSI interference measurement (CSI-IM) may be interchangeably interpreted. The CSI-RS may include other reference signals.

In the present disclosure, a measured/reported RS may mean an RS measured/reported for CSI reporting.

In the present disclosure, timing, a time point, time, a time instance, a slot, a sub-slot, a symbol, a subframe, and the like may be interchangeably interpreted.

In the present disclosure, a direction, an axis, a dimension, a domain, a polarized wave, a polarization component, and the like may be interchangeably interpreted.

In the present disclosure, the RS may be a CSI-RS, an SS/PBCH block (SS block (SSB)), or the like, for example. An RS index may be a CSI-RS resource indicator (CRI), an SS/PBCH block resource indicator (SSBRI), or the like.

In the present disclosure, the channel measurement/estimation may be performed by using at least one of a channel state information reference signal (CSI-RS), a synchronization signal (SS), a synchronization signal/broadcast channel (Synchronization Signal/Physical Broadcast Channel (SS/PBCH)) block, a demodulation reference signal (DMRS), a reference signal for measurement (Sounding Reference Signal (SRS)), and the like, for example.

In the present disclosure, the CSI may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), L1-RSRP (reference signal received power in Layer 1 (Layer 1 Reference Signal Received Power)), L1-RSRQ (Reference Signal Received Quality), an L1-SINR (Signal to Interference plus Noise Ratio), an L1-SNR (Signal to Noise Ratio), information related to a channel matrix (or channel coefficient), information related to a precoding matrix (or precoding coefficient), and the like.

In the present disclosure, UCI, CSI reporting, CSI feedback, feedback information, feedback bit, and the like may be interchangeably interpreted. In the present disclosure, a bit, a bit string, a bit sequence, a sequence, a value, information, a value obtained from a bit, information obtained from a bit, and the like may be interchangeably interpreted.

In the following embodiments, description will be given of an AI model related to UE-BS communication, and hence related subjects are a UE and a BS. However, application of each of the embodiments of the present disclosure is not limited to this. For example, for communication between different subjects (for example, UE-UE communication), the UE and the BS in the following embodiments may be interpreted as a first UE and a second UE. In other words, the UE, the BS, and the like in the present disclosure may be interpreted as any UE/BS.

### (Radio Communication Method)

In the present disclosure below, a result (measurement result) predicted/measured by a UE will be described by using an L1-RSRP as an example thereof, but is not limited to this. The L1-RSRP may be interpreted as an L1-SINR or a report quantity of any CSI.

### <First Embodiment>

Reporting of beam prediction will be described in a first embodiment.

### «Embodiment 1-1»

One or more resources for beam prediction may be configured for a UE. The one or more resources may be resource(s) for the UE performing measurement (for the beam prediction).

In the present disclosure, the one or more resources may be referred to as resource(s) for beam measurement, resource(s) for beam prediction input, set B, resource(s) of set B, a first (or second) set, resource(s) of a first (or second) set, and the like. Note that the name of the one or more resources is not limited to these.

For example, the UE may calculate/control input into a beam prediction model, based on measurement of the resource(s) of set B.

One or more resources for performing beam prediction may be configured for the UE.

In the present disclosure, the one or more resources may be referred to as resource(s) for beam prediction, resource(s) for a beam report, resource(s) included in a CSI report, set A, resource(s) of set A, a second (or first) set, second (or first) resource(s), and the like. Note that the name of the one or more resources is not limited to these.

The UE may perform beam prediction in a resource (set A) reported by using a CSI report.

The UE may report, based on the performed beam prediction, a predicted measurement result (for example, an L1-RSRP) . For example, the UE may report, based on the beam prediction, a predicted L1-RSRP.

For example, the UE may be configured with the number of RS resources reported (RS resources predicted) for each report setting (for example, N (which is any positive integer)).

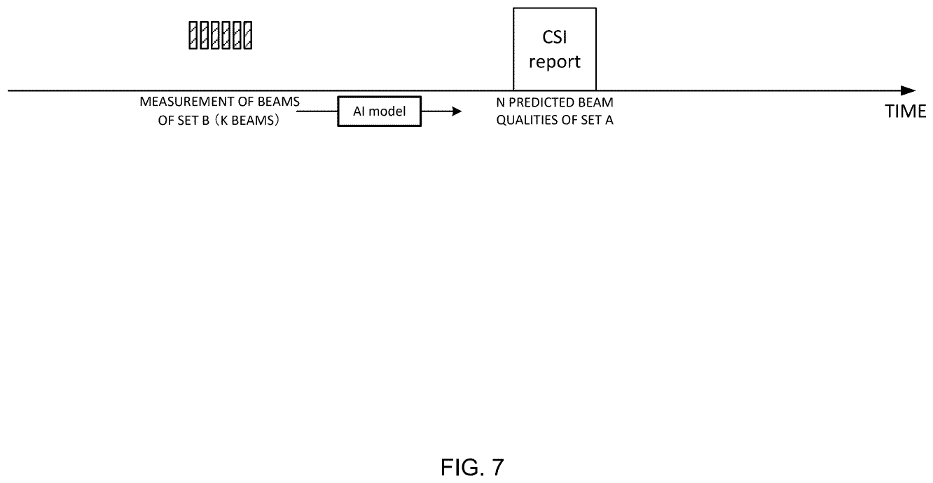

FIG. 7 is a diagram to show an example of the beam prediction according to Embodiment 1-1. In the example shown in FIG. 7, the UE measures a beam/RS included in set B. Subsequently, the UE performs beam prediction based on the measurement of set B. The UE reports a CSI report including N beam qualities (for example, L1-RSRPs and CRIS/SSBRIs corresponding to the L1-RSRPs) included in set A.

### «Embodiment 1-2»

The UE may report an L1-RSRP predicted in a specific case.

The specific case may be, for example, at least one of Options 1-2-1 to 1-2-3 below.

### {Option 1-2-1}

The UE may report the predicted L1-RSRP when a specific value is configured/indicated in a specific parameter.

The specific parameter may be notified to the UE by higher layer signaling (for example, an RRC parameter/MAC CE).

For example, the RRC parameter may be included in a CSI report configuration (for example, CSI-ReportConfig). For example, the RRC parameter may be included in a report quantity parameter (for example, reportQuantity) included in the CSI report configuration (for example, CSI-ReportConfig).

For example, the RRC parameter may indicate an RS resource (for example, a CRI/SSB index) for L1-RSRP measurement.

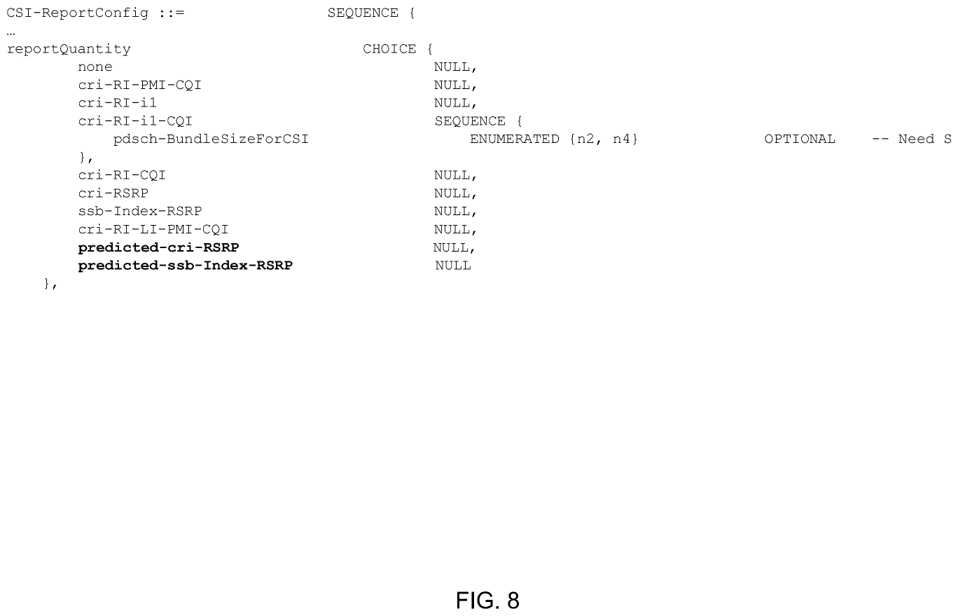

FIG. 8 is a diagram to show an example of the RRC parameter according to Option 1-2-1. FIG. 8 is described by using ASN.1 (Abstract Syntax Notation One) notation. The drawings showing configuration/RRC parameter/information element in the present disclosure below are also described by using ASN.1 notation.

In the example shown in FIG. 8, the report quantity parameter (reportQuantity) included in the CSI report configuration (CSI-ReportConfig) includes a parameter (predicted-cri-RSRP) indicating that measurement of the predicted L1-RSRP is computed by using a CSI-RS (CRI), and a parameter (predicted-ssb-Index-RSRP) indicating that measurement of the predicted L1-RSRP is computed by using an SSB (SSBRI).

When predicted-cri-RSRP is configured, the UE determines to perform beam prediction for L1-RSRP using a CSI-RS. When predicted-ssb-Index-RSRP is configured, the UE determines to perform beam prediction for L1-RSRP using an SSB.

### {Option 1-2-2}

The UE may report the predicted L1-RSRP when a specific AI model is activated.

The specific AI model may be, for example, an AI model associated with a predicted beam.

### {Option 1-2-3}

The UE may report the predicted L1-RSRP when a specific AI model is configured/registered.

The specific AI model may be, for example, an AI model associated with a predicted beam.

At least two of Options 1-2-1 to 1-2-3 described above may be applied in combination.

For example, the UE may report the predicted L1-RSRP when a specific RRC parameter (for example, a parameter for an RS resource for L1-RSRP measurement for beam prediction) is configured for the UE, and a specific AI model is activated.

According to the first embodiment above, it is possible to appropriately define configuration/operation for beam measurement/prediction/reporting.

### <Second Embodiment>

Correspondence/mapping between an RS to be measured/RS reported with a beam/beam will be described in a second embodiment.

### «Embodiment 2-1»

A UE may separately determine an RS (for example, a CSI-RS/SSB) to be measured and an RS to be reported.

The UE may report an L1-RSRP of an RS different from the RS to be measured. The UE may support reporting of the L1-RSRP of the RS different from the RS to be measured.

The UE may determine the RS to be measured and the RS to be reported, in accordance with at least one of Options 2-1-1 to 2-1-5 below.

{Option 2-1-1} The UE may determine an RS by using a specific RRC parameter.

For example, the UE may determine the RS by using an existing RRC parameter (defined in Rel. 16/17 (or earlier versions)).

The RRC parameter may be included, for example, in a parameter for configuring a resource for channel measurement/interference measurement. The RRC parameter may be, for example, an RRC parameter included in a CSI report configuration (for example, CSI-ReportConfig).

The UE may be configured with a CSI resource configuration (for example, CSI-ResourceConfig) including a CSI resource reported in beam prediction.

The UE may refer to/determine, for beam prediction calculation (for example, input into an AI model), a resource corresponding to an existing RRC parameter (for example, at least one of a parameter for a resource for channel measurement (for example, resourceForChannelMeasurement) and a parameter for a resource for interference measurement (for example, csi-IM-ResourcesForInterference)).

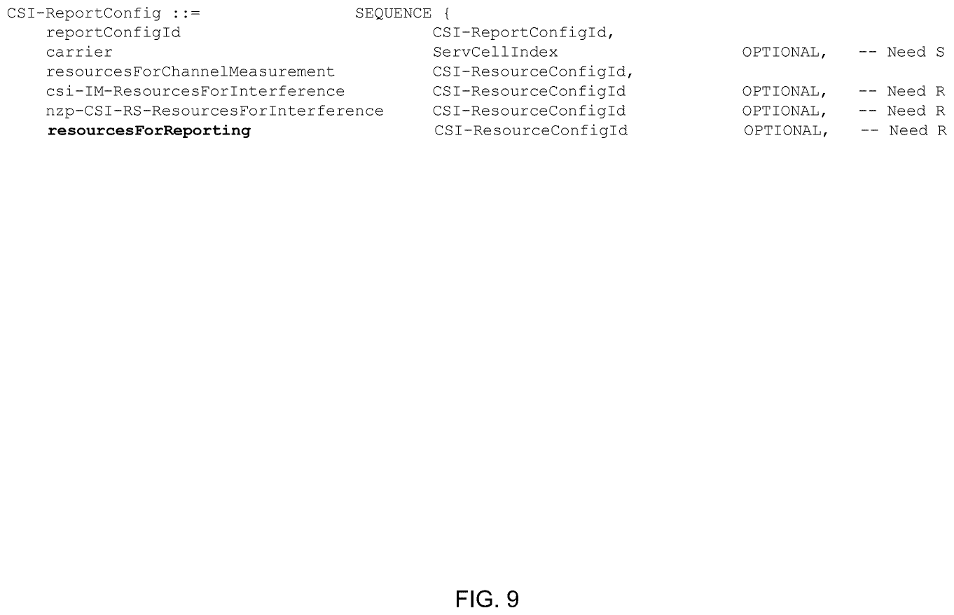

FIG. 9 is a diagram to show an example of the RRC parameter according to Option 2-1-1. In the example shown in FIG. 9, the CSI report configuration (CSI-ReportConfig) includes a parameter (resourcesForReporting) indicating a resource for reporting. The parameter (resourcesForReporting) indicating the resource for reporting refers to a CSI resource configuration ID (CSI-ResourceConfigId).

The UE determines a resource to be reported, based on CSI-ResourceConfigId referred to.

{Option 2-1-2}

The UE may determine an RS by using a specific RRC parameter.

For example, the UE may determine the RS by using a new RRC parameter (defined in Rel. 18/19 (or later versions)).

The RRC parameter may be, for example, an RRC parameter included in a CSI report configuration (for example, CSI-ReportConfig).

The RRC parameter may be configured for the UE by using a CSI resource configuration including a resource for channel measurement used for beam prediction.

The RRC parameter may be configured for the UE by using a CSI resource configuration including a resource for interference measurement/interference beam measurement used for beam prediction.

The RRC parameter may be configured for the UE by using a CSI resource configuration including a CSI resource reported in beam prediction.

### {Option 2-1-3}

The UE may determine an RS (RS resource set) by using a specific RRC parameter.

A CSI resource configuration parameter (for example, CSI-ResourceConfig) may be enhanced.

The UE may be configured with a resource set for CSI reported after beam prediction.

One CSI resource configuration parameter (for example, CSI-ResourceConfig) may include both information related to a resource set to be reported and information related to a resource set measured for beam prediction (Option 2-1-3-1).

One CSI resource configuration parameter (for example, CSI-ResourceConfig) may include either information related to a resource set to be reported or information related to a resource set measured for beam prediction (Option 2-1-3-2). In this case, the UE may be configured with two or more CSI resource configuration parameters (for example, CSI-ResourceConfig).

### {Option 2-1-4}

The UE may determine an RS (RS resource) by using a specific RRC parameter.

A resource set-related parameter may be enhanced.

For example, the UE may be configured with a parameter (for example, NZP-CSI-RS-ResourceSet) related to a resource set including a resource to be reported and a resource measured for beam prediction.

### {Option 2-1-5}

A list including at least one of an RS resource to be reported and an RS resource measured for beam prediction may be defined.

The UE may determine, based on the list, at least one of an RS resource to be reported and an RS resource to be measured.

For example, the UE may be configured with a list including a resource ID/resource set ID/CSI resource configuration of a resource reported.

For example, the UE may be configured with a list including a resource ID/resource set ID/CSI resource configuration of a resource measured for beam prediction.

One list may include both information related to an RS resource to be reported and information related to an RS resource measured for beam prediction.

One list may include either information related to an RS resource to be reported or information related to an RS resource measured for beam prediction.

At least two of Options 2-1-1 to 2-1-5 described above may be applied in combination.

Note that, in the present disclosure, a CSI-RS resource set, a configuration parameter for a CSI-RS resource set, an NZP CSI-RS resource set, a configuration parameter for an NZP CSI-RS resource set (NZP-CSI-RS-ResourceSet), a configuration parameter for an SSB resource set for CSI measurement (CSI-SSB-ResourceSet), and a configuration parameter for a CSI-IM resource set (CSI-IM-ResourceSet) may be interchangeably interpreted.

In the present disclosure, a CSI-RS resource, a configuration parameter for a CSI-RS resource, an NZP CSI-RS resource, and a configuration parameter for an NZP CSI-RS resource (NZP-CSI-RS-Resource) may be interchangeably interpreted.

### «Embodiment 2-2»

The UE may expect/assume that reporting of an L1-RSRP of an RS different from an RS to be measured is configured in a specific condition.

The specific condition may be, for example, a case where a specific AI model is activated.

The specific condition may be, for example, a case where a specific AI model associated with beam prediction is activated.

The specific condition may be, for example, a case where a specific AI model associated with beam prediction of a specific type is activated.

The beam prediction of the specific type may be, for example, spatial-domain beam prediction.

The UE may expect/assume that at least one of an RS (CSI-RS/SSB) for channel measurement/interference measurement, an RS for L1-RSRP reporting, and the number of RS (measured RS) resources reported for each report setting is the same as information associated with each model (activated AI model).

### «Variations of Second Embodiment»

Correspondence between an RS/beam included in set A and an RS/beam included in set B will be described below.

{Option 2-a}

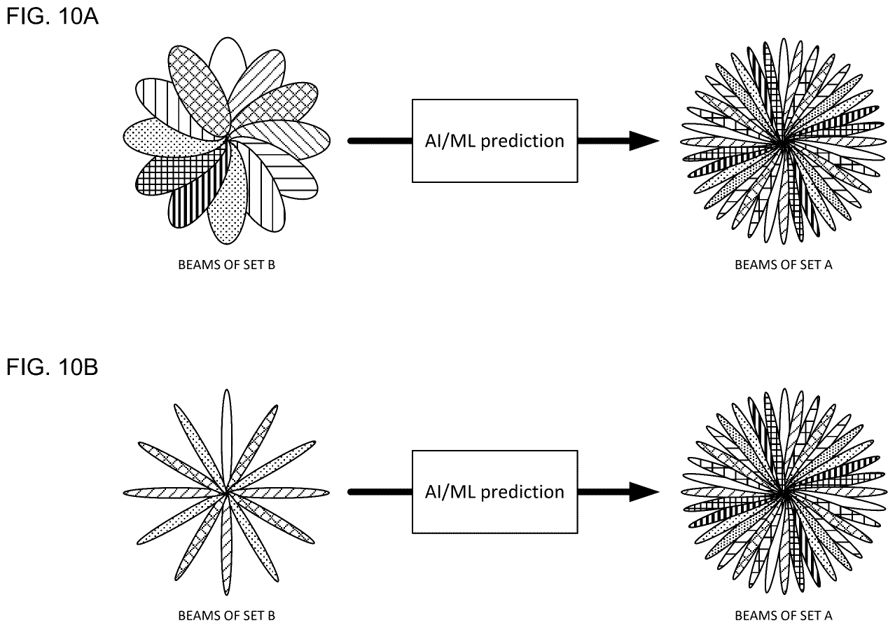

The correspondence will be described below by using FIG. 10A. FIG. 10A shows an example in which a beam of set B is broader than a beam of set A.

The UE may measure an RS/beam of set B. The UE may perform beam prediction after the beam measurement, and may report an RS/beam on which the beam prediction is performed, the RS/beam being included in set A.

The RS/beam included in set B may be broader than the RS/beam included in set A.

The number of RSs/beams included in set B may be smaller than the number of RSs/beams included in set A.

The RS/beam included in set B may be different from the RS/beam included in set A.

With such configuration as that in Option 2-a, it is possible to measure an RS/beam transmitted in a broader range, with a smaller number of measured RSs/beams.

{Option 2-b}

The correspondence will be described below by using FIG. 10B. FIG. 10B shows an example in which some of beams of set A are beams of set B.

The UE may measure an RS/beam of set B. The UE may perform beam prediction after the beam measurement, and may report an RS/beam on which the beam prediction is performed, the RS/beam being included in set A.

The RS/beam included in set B may have the same width as that of the RS/beam included in set A.

The number of RSs/beams included in set B may be smaller than the number of RSs/beams included in set A.

The RS/beam included in set B may be some (subset) of RSs/beams included in set A.

With such configuration as that in Option 2-b, it is possible to also utilize a result of a measured beam for reporting.

An RS resource to be reported may be determined/selected from a resource measured for a CSI report and a resource configured for reporting.

An RS resource to be reported may be determined/selected from resources configured for reporting.

According to the second embodiment above, it is possible to appropriately define correspondence/mapping between an RS to be measured/RS reported with a beam/beam.

### <Third Embodiment>

A size/bit width related to a predicted L1-RSRP will be described in a third embodiment.

The UE may perform reporting related to a predicted L1-RSRP. The reporting related to the predicted L1-RSRP may be quantized in accordance with at least one of Options 3-1 and 3-2 below.

### {Option 3-1}

A field/bit structure related to the predicted L1-RSRP may be the same as a field/bit structure related to an existing L1-RSRP (defined in Rel. 16/17 (or earlier versions)).

In the present disclosure, the existing L1-RSRP (defined in Rel. 16/17 (or earlier versions)) may be an L1-RSRP excluding (or different from) the predicted L1-RSRP.

In the present disclosure, a CRI/SSBRI associated with the existing L1-RSRP (defined in Rel. 16/17 (or earlier versions)) may be a CRI/SSBRI associated with an L1-RSRP excluding (or different from) the predicted L1-RSRP.

A bit width of a field for reporting the CRI/SSBRI may be determined based on the number of CSI-RS resources corresponding to a resource set of at least one of set A and set B.

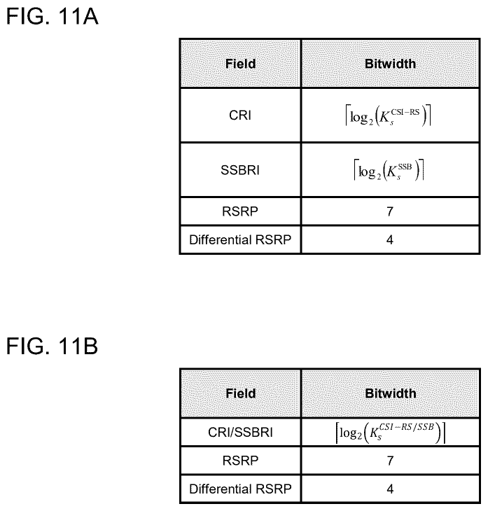

The bit width of the CRI field may be expressed as ceil (log₂ (Kₛ^{CSI-RS})) (see FIG. 11A). In the present disclosure, ceil (X) may mean multiplying X by a ceiling function.

For example, Kₛ^{CSI-RS} may be the number of CSI-RS resources corresponding to a resource set of set A.

For example, Kₛ^{CSI-RS} may be the number of CSI-RS resources corresponding to resource sets of set A and set B. When set B is a subset of set A, it is conceivable that an L1-RSRP of set B in particular is effective for management of a narrow beam.

The bit width of the SSBRI field may be expressed as ceil (log₂ (Kₛ^{SSB})) (see FIG. 11A).

For example, Kₛ^{SSB} may be the number of resources of an SS/PBCH block corresponding to a resource set of set A.

For example, Kₛ^{SSB} may be the number of resources of an SS/PBCH block corresponding to resource sets of set A and set B.

Note that FIGS. 11A and 11B below each shows an example in which a bit width of an RSRP and a bit width of a differential RSRP are 7 bits and 4 bits, respectively, but these are merely examples.

The bit width of the RSRP and the bit width of the differential RSRP may be greater than 7 bits and 4 bits, respectively.

The RSRPs in FIGS. 11A and 11B below may be replaced with SINRS.

### {Option 3-2}

A field/bit structure related to the predicted L1-RSRP may be different from a field/bit structure related to an existing L1-RSRP (defined in Rel. 16/17 (or earlier versions)).

One field for reporting a CRI and an SSBRI may be defined.

A bit width of the field may be determined based on the number of CSI-RS resources corresponding to a resource set of at least one of set A and set B.

The bit width of the field may be expressed as ceil (log₂ (Kₛ^{CSI-RS/SSBRI})) (see FIG. 11B). In the present disclosure, ceil (X) may mean multiplying X by a ceiling function.

For example, Kₛ^{CSI-RS/SSBRI} may be the number of CSI-RS/SSB resources corresponding to a resource set of set A.

For example, Kₛ^{CSI-RS/SSBRI} may be the number of CSI-RS/SSB resources corresponding to resource sets of set A and set B.

According to Option 3-2, for example, when set B and set A correspond to an SSB and a CSI-RS, respectively, it is possible to determine an RS to be reported from among set A and set B in one CSI report.

According to the third embodiment above, it is possible to appropriately define a bit width/size related to a predicted L1-RSRP.

### <Fourth Embodiment>

Two-stage/step beam measurement (channel measurement/interference measurement) will be described in a fourth embodiment.

### «Embodiment 4-1»

A UE may measure an RS (CSI-RS/SSB) resource, based on beam prediction.

The UE may perform two-stage/step beam measurement.

The UE may determine, based on beam prediction calculated by first measurement, measurement of K RS resources from resources configured for second measurement (which may be referred to as “candidate resources” in the present disclosure).

In the first measurement, the UE may determine measurement resources in the second measurement. In the second measurement, the UE may perform measurement for reporting.

The UE may report an L1-RSRP, based on at least one of L1-RSRPs measured/predicted in the second measurement and the first measurement.

The UE may be configured with the number (K′ which is any positive integer) of resources of a measured RS reported for each report setting.

The UE may be configured with the number (K which is any positive integer) of resources of an RS measured in the second measurement.

K and K′ may be different numbers. The UE may assume that K and K′ are different numbers.

K and K′ may be the same number. The UE may assume that K and K′ are the same number.

Difference between K and K′ may be determined in accordance with reported UE capability information.

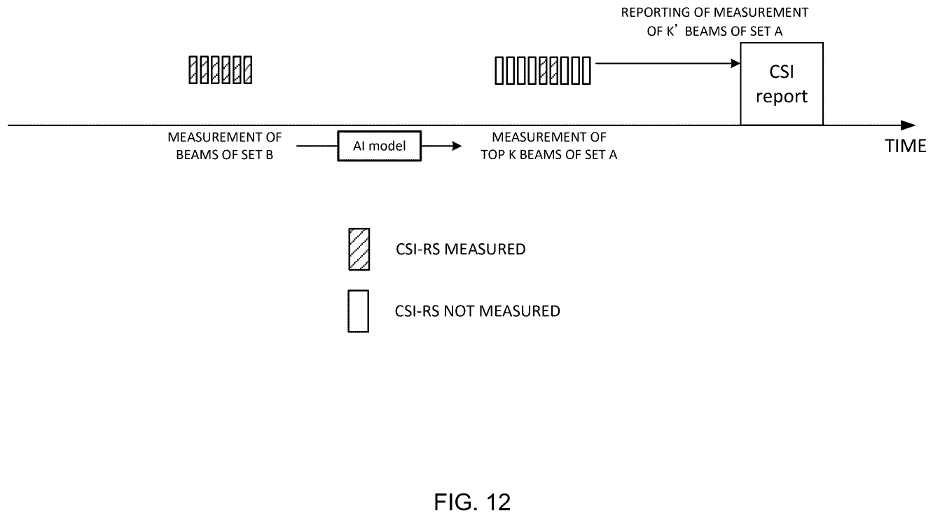

FIG. 12 is a diagram to show an example of the two-stage beam measurement according to Embodiment 4-1. In the example shown in FIG. 12, the UE measures a beam/RS in set B and predicts a beam/RS in set A.

Subsequently, the UE measures the top K beams/RSs (K is a specific positive integer) predicted to have good qualities, from among beams of set A.

Furthermore, the UE reports CRIS/SSBRIs having good qualities and corresponding to the top K′ beams/RSs (K′ is a specific positive integer) from among the K measured beams/RSs, and beam qualities (for example, L1-RSRPs/L1-SINRs) corresponding to the CRIS/SSBRIS.

The UE may be configured with the number (for example, K) of resources of an RS (CSI-RS/SSB) measured after the beam prediction.

In the second measurement, the UE may measure K RS resources.

The UE may be configured with a maximum number of resources of an RS (CSI-RS/SSB) measured after the beam prediction.

In the second measurement, the UE may measure a resource of an RS (CSI-RS/SSB) that has not been measured in the first measurement.

In this case, the number of measured resources may be the configured maximum number or below.

### «Embodiment 4-2»

The UE may perform two-stage/step beam measurement (channel measurement/interference measurement) in a specific condition.

The specific case may be, for example, at least one of Options 4-2-1 to 4-2-3 below.

{option 4-2-1}

The UE may perform the two-stage/step beam measurement (channel measurement/interference measurement) when a specific value is configured/indicated in a specific parameter.

The specific parameter may be notified to the UE by higher layer signaling (for example, an RRC parameter/MAC CE).

For example, the RRC parameter may be included in a CSI report configuration (for example, CSI-ReportConfig). For example, the RRC parameter may be included in a report quantity parameter (for example, reportQuantity) included in the CSI report configuration (CSI-ReportConfig).

For example, the RRC parameter may indicate an RS resource (for example, a CRI/SSB index) for L1-RSRP measurement in first measurement/second measurement.

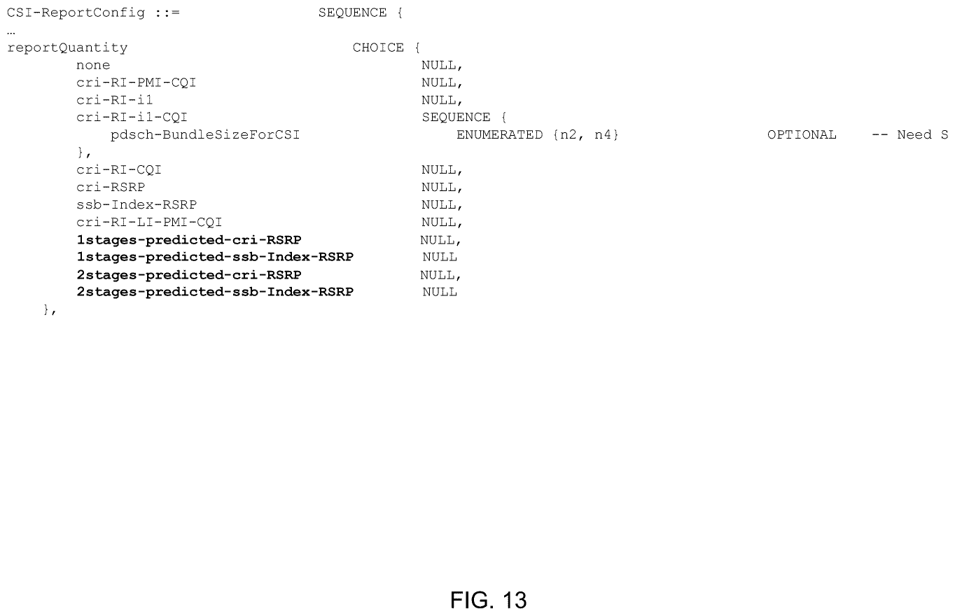

FIG. 13 is a diagram to show an example of the RRC parameter according to Option 4-2-1.

In the example shown in FIG. 13, the report quantity parameter (reportQuantity) included in the CSI report configuration (CSI-ReportConfig) includes a parameter (1stages-predicted-cri-RSRP) indicating that measurement of a predicted L1-RSRP for the first measurement is computed by using a CSI-RS (CRI), a parameter (2stages-predicted-cri-RSRP) indicating that measurement of a predicted L1-RSRP for the second measurement is computed by using a CSI-RS (CRI), a parameter (1stages-predicted-ssb-Index-RSRP) indicating that measurement of a predicted L1-RSRP for the first measurement is computed by using an SSB (SSBRI), and a parameter (2stages-predicted-ssb-Index-RSRP) indicating that measurement of a predicted L1-RSRP for the second measurement is computed by using an SSB (SSBRI).

When 1stages-predicted-cri-RSRP is configured, the UE determines to perform, in the first measurement, beam prediction for L1-RSRP using a CSI-RS. When 1stages-predicted-ssb-Index-RSRP is configured, the UE determines to perform, in the first measurement, beam prediction for L1-RSRP using an SSB.

When 2stages-predicted-cri-RSRP is configured, the UE determines to perform, in the second measurement, beam prediction for L1-RSRP using a CSI-RS. When 2stages-predicted-ssb-Index-RSRP is configured, the UE determines to perform, in the second measurement, beam prediction for L1-RSRP using an SSB.

### {Option 4-2-2}

The UE may perform the two-stage/step beam measurement (channel measurement/interference measurement) when a specific AI model is activated.

The specific AI model may be, for example, an AI model associated with a predicted beam.

### {Option 4-2-3}

The UE may perform the two-stage/step beam measurement (channel measurement/interference measurement) when a specific AI model is configured/registered.

The specific AI model may be, for example, an AI model associated with a predicted beam.

At least two of Options 4-2-1 to 4-2-3 described above may be applied in combination.

For example, the UE may perform the two-stage/step beam measurement (channel measurement/interference measurement) when a specific RRC parameter (for example, a parameter for an RS resource for L1-RSRP measurement for beam prediction) is configured for the UE, and a specific AI model (for example, an AI model for the top K beam predictions) is activated.

According to the fourth embodiment above, it is possible to appropriately define configuration/operation for two-stage/step beam measurement (channel measurement/interference measurement).

### <Fifth Embodiment>

Determination of a resource in two-stage/step beam measurement will be described in a fifth embodiment.

### «Embodiment 5-1»

The UE may determine at least one of an RS resource and an RS resource to be reported in first measurement/second measurement, in accordance with at least one of Options 5-1-1 to 5-1-5 below.

{Option 5-1-1} The UE may determine an RS resource by using a specific RRC parameter.

For example, the UE may determine the RS resource by using an existing RRC parameter (defined in Rel. 16/17 (or earlier versions)).

The RRC parameter may be included, for example, in a parameter for configuring a resource for channel measurement/interference measurement. The RRC parameter may be, for example, an RRC parameter included in a CSI report configuration (for example, CSI-ReportConfig).

The UE may be configured with a CSI resource configuration (for example, CSI-ResourceConfig) including at least one of a CSI (RS) resource (for example, CSI resource for input into an AI model) used for beam prediction and a candidate resource having a possibility of being measured after the beam prediction.

The UE may refer to/determine, for at least one of beam prediction calculation (for example, input into the AI model) and the candidate resource after the beam prediction, a resource corresponding to an existing RRC parameter (for example, at least one of a parameter for a resource for channel measurement (for example, resourceForChannelMeasurement) and a parameter for a resource for interference measurement (for example, csi-IM-ResourcesForInterference)).

Note that, in the present disclosure, a resource for the first measurement, a resource used for beam prediction, a resource for beam prediction calculation, a resource for input into an AI model, and a resource corresponding to set B may be interchangeably interpreted.

In the present disclosure, a resource for the second measurement, a resource used after beam prediction, a resource having a possibility of being measured after beam prediction, a candidate resource after beam prediction, a candidate resource, a measurement resource corresponding to set A, and the top K measurement resources corresponding to set A may be interchangeably interpreted. The resource for the first measurement, a resource having a possibility of being measured in the second measurement, a candidate resource, and a candidate resource having a possibility of being measured after beam prediction may be interchangeably interpreted.

Operation according to Option 5-1-1 will be described by using FIG. 9 described above. The UE determines a resource to be reported, based on CSI-ResourceConfigId referred to by a parameter (resourcesForReporting) indicating a resource for reporting included in a CSI report configuration (CSI-ReportConfig).

{Option 5-1-2}

The UE may determine an RS resource by using a specific RRC parameter.

For example, the UE may determine the RS resource by using a new RRC parameter (defined in Rel. 18/19 (or later versions)).

The RRC parameter may be, for example, an RRC parameter included in a CSI report configuration (CSI-ReportConfig).

The RRC parameter may be configured for the UE by using a CSI resource configuration including a resource for channel measurement. The resource for channel measurement may be a resource used for beam prediction.

The RRC parameter may be configured for the UE by using a CSI resource configuration including a resource for interference measurement/interference beam measurement. The resource for interference measurement/interference beam measurement may be a resource used for beam prediction.

The RRC parameter may be configured for the UE by using a CSI resource configuration including a resource for channel measurement. The resource for channel measurement may be a resource used for a candidate resource after beam prediction.

The RRC parameter may be configured for the UE by using a CSI resource configuration including a resource for interference measurement/interference beam measurement. The resource for interference measurement/interference beam measurement may be a resource used for a candidate resource after beam prediction.

### {Option 5-1-3}

The UE may determine an RS (RS resource set) by using a specific RRC parameter.

A CSI resource configuration parameter (for example, CSI-ResourceConfig) may be enhanced.

The UE may be configured with at least one of a CSI resource for the beam prediction and a resource for the candidate resource after the beam prediction.

One CSI resource configuration parameter (for example, CSI-ResourceConfig) may include both information related to a resource set used for beam prediction and information related to a resource set measured for a candidate resource after the beam prediction

### (Option 5-1-3-1).

One CSI resource configuration parameter (for example, CSI-ResourceConfig) may include either information related to a resource set used for beam prediction or information related to a resource set measured for a candidate resource after the beam prediction (Option 5-1-3-2). In this case, the UE may be configured with two or more CSI resource configuration parameters (for example, CSI-ResourceConfig).

### {Option 5-1-4 }

The UE may determine an RS (RS resource) by using a specific RRC parameter.

A resource set-related parameter may be enhanced.

For example, the UE may be configured with a parameter (for example, NZP-CSI-RS-ResourceSet) related to a resource set including a resource used for beam prediction and a candidate resource measured after the beam prediction.

### {Option 5-1-5}

A list including at least one of an RS resource to be reported and an RS resource measured for beam prediction may be defined.

The UE may determine, based on the list, at least one of an RS resource to be reported and an RS resource to be measured.

For example, the UE may be configured with a list including a resource ID/resource set ID/CSI resource configuration of a resource (candidate resource) having a possibility of being measured after beam prediction.

For example, the UE may be configured with a list including a resource ID/resource set ID/CSI resource configuration of a resource measured for beam prediction.

One list may include both information related to an RS resource (candidate resource) having a possibility of being measured after beam prediction, and information related to an RS resource measured for beam prediction.

One list may include either information related to an RS resource (candidate resource) having a possibility of being measured after beam prediction, or information related to an RS resource measured for beam prediction.

At least two of Options 5-1-1 to 5-1-5 described above may be applied in combination.

### «Embodiment 5-2»

The UE may expect/assume that reporting of two-stage/step beam measurement is configured in a specific condition.

The specific condition may be, for example, a case where a specific AI model is activated.

The specific condition may be, for example, a case where a specific AI model associated with beam prediction is activated.

The specific condition may be, for example, a case where a specific AI model associated with beam prediction of a specific type is activated.

The beam prediction of the specific type may be, for example, (the top K) spatial-domain beam prediction(s).

The UE may expect/assume that at least one of an RS (CSI-RS/SSB) for channel measurement/interference measurement, an RS for L1-RSRP reporting, and the number of RS (measured RS) resources reported for each report setting is the same as information associated with each model (activated AI model).

### «Variations of Fifth Embodiment»

Correspondence between an RS/beam for the first/second measurement and an RS/beam for the reporting will be described below.

{Option 5-a}

The UE may report an L1-RSRP for at least one RS of RSs (CSI-RSs/SSBs) configured for the second measurement.

{Option 5-b}

The UE may report an L1-RSRP for at least one RS from among an RS configured for the first measurement and an RS configured for the second measurement.

According to the fifth embodiment above, it is possible to appropriately determine a resource in two-stage/step beam measurement.

### <Sixth Embodiment>

A size/bit width related to an L1-RSRP reported in two-stage/step beam measurement will be described in a sixth embodiment.

The UE may perform reporting related to an L1-RSRP, based on two-stage/step beam measurement. The reporting related to the L1-RSRP may be quantized in accordance with at least one of Options 6-1 and 6-2 below.

### {Option 6-1}

A field/bit structure related to the L1-RSRP may be the same as a field/bit structure related to an existing L1-RSRP (defined in Rel. 16/17 (or earlier versions)).

In the present disclosure, the existing L1-RSRP (defined in Rel. 16/17 (or earlier versions)) may be an L1-RSRP excluding (or different from) the L1-RSRP measured/predicted based on the two-stage/step beam measurement.

In the present disclosure, a CRI/SSBRI associated with the existing L1-RSRP (defined in Rel. 16/17 (or earlier versions)) may be a CRI/SSBRI associated with an L1-RSRP excluding (or different from) the L1-RSRP measured/predicted based on the two-stage/step beam measurement.

A bit width of a field for reporting the CRI/SSBRI may be determined based on the number of CSI-RS resources corresponding to a resource set of at least one of set A and set B.

The bit width of the CRI field may be expressed as ceil (log₂ (Kₛ^{CSI-RS})) (see FIG. 11A described above).

For example, Kₛ^{CSI-RS} may be the number of CSI-RS resources corresponding to a resource set of set A.

For example, Kₛ^{CSI-RS} may be the number of CSI-RS resources corresponding to resource sets of set A and set B. When set B is a subset of set A, it is conceivable that an L1-RSRP of set B in particular is effective for management of a narrow beam.

The bit width of the SSBRI field may be expressed as ceil (log₂ (Kₛ^{SSB})) (see FIG. 11A described above).

For example, Kₛ^{SSB} may be the number of resources of an SS/PBCH block corresponding to a resource set of set A.

For example, Kₛ^{SSB} may be the number of resources of an SS/PBCH block corresponding to resource sets of set A and set B.

### {Option 6-2}

A field/bit structure related to the predicted L1-RSRP may be different from a field/bit structure related to an existing L1-RSRP (defined in Rel. 16/17 (or earlier versions)).

One field for reporting a CRI and an SSBRI may be defined.

A bit width of the field may be determined based on the number of CSI-RS resources corresponding to a resource set of at least one of set A and set B.

The bit width of the field may be expressed as ceil (log₂ (Kₛ^{CSI-RS/SSBRI})) (see FIG. 11B described above). In the present disclosure, ceil (X) may mean multiplying X by a ceiling function.

For example, Kₛ^{SI-RS/SSBRI} may be the number of CSI-RS/SSB resources corresponding to a resource set of set A.

For example, Kₛ^{CSI-RS/SSBRI} may be the number of CSI-RS/SSB resources corresponding to resource sets of set A and set B.

According to Option 6-2, for example, when set B and set A correspond to an SSB and a CSI-RS, respectively, it is possible to select/determine an RS to be reported from among set A and set B in one CSI report.

According to the sixth embodiment above, it is possible to appropriately define a bit width/size related to an L1-RSRP based on two-stage/step beam measurement.

### <Seventh Embodiment>

Request time/timeline for determination of set A (candidate resource set) in two-stage/step beam measurement will be described in a seventh embodiment.

A UE may perform measurement (second measurement) of an RS resource selected based on first measurement (and beam prediction based on the first measurement).

The second measurement may be based on the first measurement (resource) arranged (located) specific time (for example, time A)/period or more before a timing of a measurement resource in the second measurement (for example, the first symbol/slot).

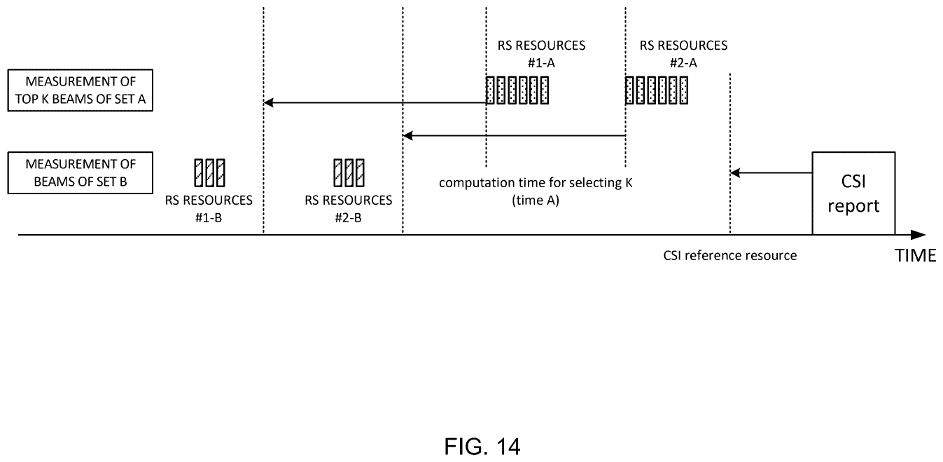

FIG. 14 is a diagram to show an example of the timeline according to the seventh embodiment. In the example shown in FIG. 14, the UE performs the second measurement, based on the first measurement (resource) arranged (located) specific time (time A) or more before the first symbol/slot for a measurement resource in the second measurement.

In the example shown in FIG. 14, the UE performs measurement of RS resources #1-A of set A, based on measurement of RS resources #1-B of set B satisfying the time requirement. The UE performs measurement of RS resources #2-A of set A, based on measurement of RS resources #2-B of set B satisfying the time requirement.

In the second measurement, after a lapse of specific time (for example, time A)/period since the last symbol/slot for an RS resource in the first measurement, the UE may measure a resource selected by using beam prediction based on the first measurement.

In the present disclosure, time A may be represented by specific time resource(s). For example, time A may be represented by X symbol(s)/slot(s)/subframe(s) /ms (X is any number).

At least one of time A and X may be determined based on at least one piece of information described in Supplement 2 below, may be determined based on UE capability information, or may be predefined in a specification.

At least one of time A and X may be determined in accordance with at least one of configured numerology (for example, configuration of subcarrier spacing), a (RS) resource type, and a (CSI) report type.

For example, the resource/report type may be, for example, at least one of periodic, semi-persistent, and aperiodic.

According to the seventh embodiment above, it is possible to appropriately define request time for determination of a resource in two-stage/step beam measurement.

### <Eighth Embodiment>

A timeline/request time for calculation of CSI in two-stage/step beam measurement will be described in an eighth embodiment.

A CSI report in a PUSCH/PUCCH may be triggered for the UE by using a CSI request field included in DCI (PDCCH).

When a timing of transmission of at least one of a corresponding CSI report and the n th CSI report (for example, the first UL symbol) is not started before a specific symbol (which may be referred to as, for example, a reference symbol), the UE may determine that a report requiring two-stage/step beam measurement and triggered n th is enabled. In this case, the UE may report the CSI report.

At least one of the corresponding CSI report and the n th CSI report may include an effect of a timing advance.

The reference symbol may be a subsequent UL symbol in which a cyclic prefix (CP) is started after a lapse of specific time.

For example, the UE may determine that a CSI report arranged (located) in a resource specific time (time X in FIG. 6B described above) after an end of the last symbol for a PDCCH for triggering a CSI report is an enabled CSI report (Option 8-1).

For example, the UE may determine that a CSI report arranged in a resource specific time (time Y in FIG. 6B described above) after an end of the last symbol in the latest time in RS resources in first measurement is an enabled CSI report (Option 8-2). The RS resource may be a resource for channel measurement/interference measurement.

For example, the UE may determine that a CSI report arranged in a resource specific time (time Z in FIG. 6B described above) after an end of the last symbol in the latest time in RS resources in second measurement is an enabled CSI report (Option 8-3). The RS resource may be a resource for channel measurement/interference measurement.

Note that at least two of Options 8-1 to 8-3 described above may be applied in combination. For example, the UE may determine that the CSI report is enabled when the conditions in Options 8-1 to 8-3 described above are satisfied.

In the present disclosure, the specific time (for example, time X/time Y/time Z) may be represented by specific time resource(s). For example, the specific time (for example, time X/time Y/time Z) may be represented by X symbol(s)/slot(s)/subframe(s)/ms (X is any number).

The specific time (for example, time X/time Y/time Z) may be determined based on at least one piece of information described in Supplement 2 below, may be determined based on UE capability information, or may be predefined in a specification.

The specific time (for example, time X/time Y/time Z) may be determined in accordance with at least one of configured numerology (for example, configuration of subcarrier spacing), information associated with an AI model, and a specific RRC parameter.

According to the eighth embodiment above, it is possible to appropriately define a timeline/request time for calculation of CSI in two-stage/step beam measurement.

### <Variations of Fourth to Eighth Embodiments>

In the embodiment related to the two-stage/step beam measurement in the present disclosure (for example, at least one of the fourth to eighth embodiments), beam prediction may not be performed.

In other words, the embodiment related to the two-stage/step beam measurement in the present disclosure (for example, at least one of the fourth to eighth embodiments) may be applied without beam prediction.

An RS resource in the first measurement and an RS resource in the second measurement may be associated with each other. In this case, the UE may apply the two-stage/step beam measurement.

The UE may receive information indicating correspondence/mapping between an RS resource in the first measurement and an RS resource in the second measurement. The UE may determine the correspondence/mapping, based on a specific rule.

The information may be configured/activated for the UE, for example, by using higher layer signaling (RRC signaling/MAC CE).

For example, the UE may receive a sequence parameter for RS resources in the second measurement of respective RS resources.

For example, the UE may receive first information related to a resource set of RS resources in the first measurement and second information related to a resource set of RS resources in the second measurement. The UE may determine correspondence between the RS resources in the first measurement and the RS resources in the second measurement, based on the order of resource sets/resources included in the first information, and the order of resource sets/resources included in the second information.

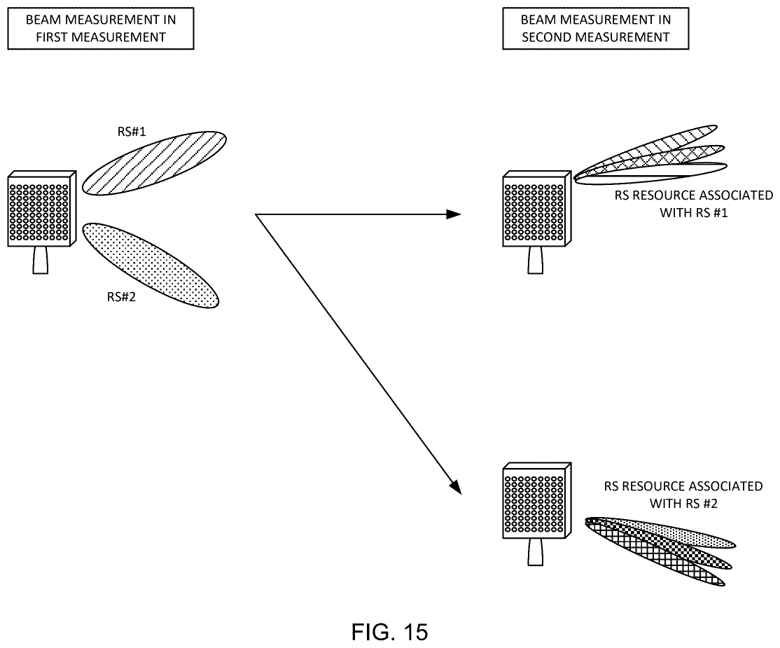

FIG. 15 is a diagram to show the correspondence between the RS resources in variations of the fourth to eighth embodiments.

As shown in FIG. 15, the UE determines an RS resource to be used for the second measurement, based on the correspondence between the RS resources (RS #1 and RS #2) in the first measurement and the RS resources in the second measurement.

### <Ninth Embodiment>

Switching/falling back from the operation described in each of the embodiments of the present disclosure will be described in a ninth embodiment.

### «Embodiment 9-1»

A UE may fall back/switch from operation/method with beam prediction to specific operation/method.

In the present disclosure, the specific operation/method may be referred to as fallback operation, a fallback scheme, and the like. The name of the specific operation is not limited to these.

In the present disclosure, the specific operation may mean operation in which an RS resource to be reported is constituted by an RS resource to be measured. The specific operation may mean operation in which a reference signal to be reported is included in a reference signal to be measured.

The falling back/switching to the operation may represent falling back/switching to operation described in at least one of Options 9-1-1 to 9-1-3 below.

### {Option 9-1-1}

The UE may measure resources of set A/set B, and may report some or all of the L1-RSRPs of the measured resources.

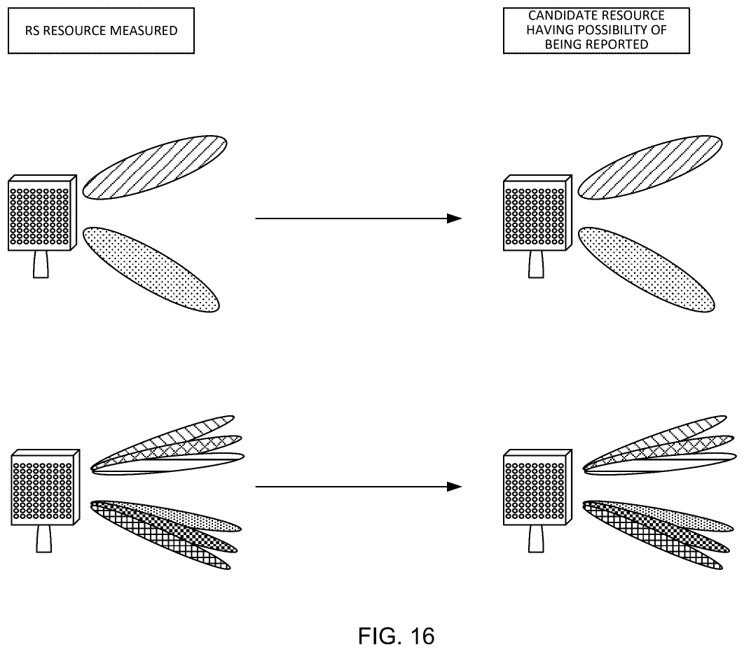

FIG. 16 is a diagram to show an example of the RS measurement/reporting according to Option 9-1-1. In the example shown in FIG. 16, the UE performs RS resource reporting for the measured RS resources.

### {Option 9-1-2}

The UE may measure specific RS resources, and may report some or all of the L1-RSRPs of the measured resources.

The specific RS resources may be RS resources used when the falling back/switching is performed (RS resources for the fallback scheme).

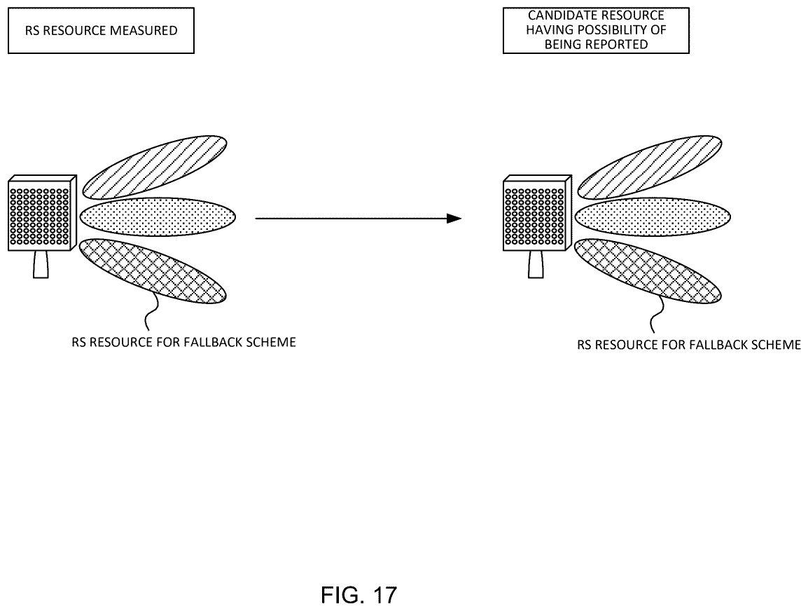

FIG. 17 is a diagram to show an example of the RS measurement/reporting according to Option 9-1-2. In the example shown in FIG. 17, the UE measures RS resources including the RS resources for the fallback scheme. Subsequently, the UE performs RS resource reporting for the measured RS resources.

### {Option 9-1-3}

The UE may measure RS resources of set B. The UE may determine RS resources to be measured in set A, without beam prediction. The UE may report some or all of the L1-RSRPs of the measured resources.

The present option may mean falling back/switching to the operations described in the variations of the fourth to eighth embodiments described above.

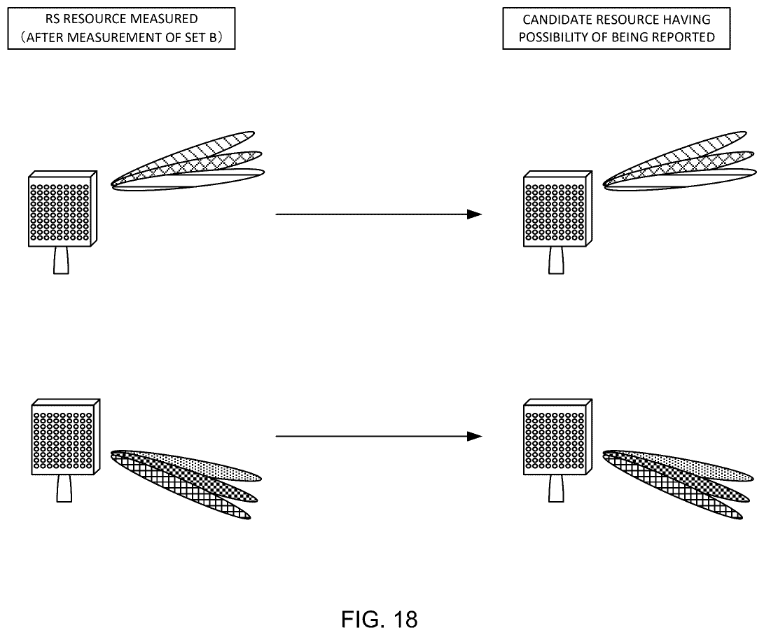

FIG. 18 is a diagram to show an example of the RS measurement/reporting according to Option 9-1-3. In the example shown in FIG. 18, the UE measures RS resources in set A without beam prediction after the measurement of set B. Subsequently, the UE performs RS resource (candidate RS resource) reporting for the measured RS resources (measured in set A).

### «Embodiment 9-2»

The UE may fall back/switch from a measurement scheme for L1-RSRP with beam prediction to a measurement scheme for L1-RSRP without beam prediction.

The UE may fall back/switch from the measurement scheme for L1-RSRP with beam prediction to the measurement scheme for L1-RSRP without beam prediction, in a specific case.

The specific case may be, for example, at least one of Options 9-2-1 to 9-2-3 below.

### {Option 9-2-1}

The UE may determine to fall back/switch to the measurement scheme for L1-RSRP without beam prediction, based on whether an AI model associated with beam prediction (of a specific type) is activated.

For example, when the AI model associated with the beam prediction (of the specific type) is not activated, the UE may determine to fall back/switch to the measurement scheme for L1-RSRP without beam prediction.

For example, when AI models associated with beam prediction of all the types are not activated, the UE may determine to fall back/switch to the measurement scheme for L1-RSRP without beam prediction.

### {Option 9-2-2}

The UE may determine to fall back/switch to the measurement scheme for L1-RSRP without beam prediction, based on specific information.

The specific information may be, for example, at least one piece of information described in Supplement 2 below.

The specific information may be, for example, information indicating falling back/switching to the measurement scheme for L1-RSRP without beam prediction. When receiving the information, the UE may determine to fall back/switch to the measurement scheme for L1-RSRP without beam prediction.

The specific information may be, for example, information indicating application of the measurement scheme for L1-RSRP with beam prediction. When not receiving the information, the UE may determine to fall back/switch to the measurement scheme for L1-RSRP without beam prediction.

### {Option 9-2-3}

The UE may determine to fall back/switch to the measurement scheme for L1-RSRP without beam prediction, based on performance monitoring.

The UE may report, to a network, which measurement scheme has been applied to L1-RSRP measurement. The report may be performed by using information described in Supplement 3 below.

The performance monitoring will be described in detail below.

The UE may determine at least one of a fallback scheme to be applied and determination of an RS resource to be measured/reported, based on configured/indicated information. The configured/indicated information may be, for example, at least one piece of information described in Supplement 2 below.

The UE may determine at least one of a fallback scheme to be applied and determination of an RS resource to be measured/reported, in accordance with procedure predefined in a specification.

According to the ninth embodiment above, it is possible to appropriately implement operation for measurement with beam prediction while maintaining compatibility.

### {Performance Monitoring}

The UE may be notified of which performance of which AI model/fallback scheme is to be monitored, from a network.

In the present disclosure, the fallback scheme may be interchangeably interpreted as a non-AI-based beam report, a beam report without prediction, and the like.

The UE may monitor performance of a certain model/fallback scheme. In the present disclosure, a model whose performance is monitored may be referred to as a monitored model. Note that a registered model (to which registration is applied)/configured model may correspond to a monitored model/activated model.

In the present disclosure, the monitored performance may be at least one of the following:
(1) an actual L1-RSRP for performance monitoring reference (without prediction),
(2) an actual L1-RSRP used for input of an AI model prediction (without prediction),
(3) a predicted L1-RSRP based on an AI model,
(4) an L1-RSRP difference between the top predicted L1-RSRP and the top L1-RSRP for the performance monitoring reference,
(5) the lowest L1-RSRP difference between one of the top K predicted L1-RSRPs and the top L1-RSRP for the performance monitoring reference,
(6) whether a CRI/SSBRI associated with one of the top K predicted L1-RSRPs corresponds to a CRI/SSBRI corresponding to the top L1-RSRP for the performance monitoring reference,
(7) whether a CRI/SSBRI associated with the top predicted L1-RSRP corresponds to one of the CRIS/SSBRIs corresponding to the top K L1-RSRPs for the performance monitoring reference,
(8) whether all the CRIS/SSBRIs associated with the top K predicted L1-RSRPs correspond to the CRIS/SSBRIs corresponding to the top K L1-RSRPs for the performance monitoring reference,
(9) accuracy (for example, rate) with which a CRI/SSBRI associated with one of the top K predicted L1-RSRPs corresponds to a CRI/SSBRI corresponding to the top L1-RSRP for the performance monitoring reference, over a certain period,
(10) accuracy (for example, rate) with which a CRI/SSBRI associated with the top predicted L1-RSRP corresponds to one of the CRIS/SSBRIs corresponding to the top K L1-RSRPs for the performance monitoring reference, over a certain period,
(11) accuracy (for example, rate) with which all the CRIS/SSBRIs associated with the top K predicted L1-RSRPs correspond to the CRIS/SSBRIs corresponding to the top K L1-RSRPs for the performance monitoring reference, over a certain period,
(12) an X % percentile of an L1-RSRP difference between the top predicted L1-RSRP and the top L1-RSRP for the performance monitoring reference, over a certain period,
(13) an X % percentile of the lowest L1-RSRP difference between one of the top K predicted L1-RSRPs and the top L1-RSRP for the performance monitoring reference, over a certain period,
(14) whether the top predicted L1-RSRP is included in Y dB of the top L1-RSRP for the performance monitoring reference over a certain period, and
(15) a percentage with which the top predicted L1-RSRP is included in Y dB of the top L1-RSRP for the performance monitoring reference over a certain period.

Note that, in the present disclosure, an L1-RSRP, an L1-SINR, and another metric (for example, an indicator for beam-related quality) may be interchangeably interpreted.

An X % percentile may mean a value located in X % of whole data in ascending order.

Values of K, X, Y, the certain period, and the like described above (or information related to the values) may be predefined in a specification, may be determined based on a UE capability, or may be notified to the UE from the NW.

### <Model Evaluation>

Model evaluation in the UE will be described below.

The UE may evaluate the performance of the models/fallback schemes described above to determine at least one of which performance is to be reported, which model/fallback scheme is to be requested, which model/fallback scheme is to be activated, and the like.

The UE may check (evaluate) whether one or more pieces of monitored performance satisfy at least one of the following conditions:
Condition 1: monitored performance of an active/registered/configured model or fallback scheme is less/greater than one monitored performance of an inactive model or fallback scheme,
Condition 2: monitored performance of a registered/configured model is greater/less than one piece of monitored performance of a fallback scheme,
Condition 3: monitored performance of a certain monitored model (for example, active model) or fallback scheme is less than a threshold,
Condition 4: monitored performance of a certain monitored model (for example, inactive model) or fallback scheme is greater than a threshold,
Condition 5: monitored performance of a certain monitored model or fallback scheme has changed more than Y times since (transmission of) the last performance report, and
Condition 6: monitored performance of a certain monitored model or fallback scheme becomes less than a threshold a certain number of times or more over a certain period.

Note that, in the present disclosure, monitored performance may be interchangeably interpreted as the performance obtained by adding offset X (X is, for example, a real number) to the monitored performance. The offset X may be determined based on a factor different from pure performance (reproducibility) (for example, unmonitored performance/performance not required to be monitored). Introducing the offset enables model evaluation with comprehensive consideration of the different factor.

Here, the unmonitored performance/performance not required to be monitored may correspond to at least one of overhead for channel measurement, reliability (of a model/computed value), model complexity, power consumption for computation, offset between predicted time and measured time, and the like.

Values of X, Y, the threshold, and the like (or information related to the values) may be predefined in a specification, may be determined based on a UE capability, or may be notified to the UE from the NW. Information related to the values of X, Y, the threshold, and the like may be defined/notified for each model/fallback scheme, may be defined/notified for each group of models/fallback schemes, or may be defined/notified for an AI-based beam report or a non-AI-based beam report.

Which (or which combination) of Conditions 1 to 6 is to be checked by the UE may be defined/notified for each model/fallback scheme, may be defined/notified for each group of models/fallback schemes, or may be defined/notified for an AI-based beam report or a non-AI-based beam report.

Condition 6 will be described more specifically. Condition 6 may include, for example, the following steps:
starting a timer when a first counter counts the monitored performance being less than a first value a first number of times or more,
while the timer is running, stopping the above-described timer when a second counter counts the monitored performance being greater than a second value a second number of times or more,
while the timer is running, resetting the second counter when the monitored performance is less than the first value,
resetting the first counter when the monitored performance is greater than the first value, and
evaluating that the performance of the monitored model is lower when the timer has expired.

Note that the first value may be a first threshold (thresholdout), or a value that is first offset (offsetout) lower than a reference value (baseline value) for a specific model/non-AI-based beam report.

Note that the second value may be a second threshold (thresholdin), or may be a value second offset (offsetin) greater than the reference value (baseline value) for the specific model/non-AI-based beam report.

Note that reset of the counter may mean that the counter is set to a specific value (for example, 0).

Here, the first/second threshold, the baseline value, the first/second offset, the first/second counter, granularity of the counter, and values of a time length of the timer and the like (or information related to the values) may be predefined in a specification, may be determined based on a UE capability, or may be notified to the UE from the NW. Information related to these values may be defined/notified for each model/non-AI-based beam report, may be defined/notified for each group of models/non-AI-based beam reports, or may be defined/notified for an AI-based beam report or a non-AI-based beam report.

In the present embodiment, the UE may evaluate performance of one or more models/fallback schemes to select (determine) the top K (where K is an integer) pieces of performance for reporting/model request/model activation/model deactivation.

These K pieces of performance described above may all be selected from performance AI-based beam reports, may all be selected from performance of non-AI-based beam reports, or may be selected from performance of AI-based CSI beam report(s) and non-AI-based beam report(s).

In other words, the UE may evaluate performance of one or more CSI feedback methods to determine the top K (where K is an integer) pieces performance from performance of AI-based beam reports and to determine the top K′ (where K′ is an integer) pieces of performance from performance of non-AI-based beam reports.

Values of K, K′, and the like (or information related to the values) may be predefined in a specification, may be determined based on a UE capability, or may be notified to the UE from the NW.

Note that, in the present disclosure, the UE may derive performance, based on one or more pieces of monitored performance and one or more pieces of unmonitored performances/performance not required to be monitored. In the present disclosure, monitored performance may be averaged/weighted over a certain period in evaluation/comparison. Information related to the period, the averaging/weighting method, and the like may be predefined in a specification, may be determined based on a UE capability, or may be notified to the UE from the NW.

### <Tenth Embodiment>

A bit width of a field for an L1-RSRP-related report (CSI report) in a case where fallback/switching operation is defined will be described in a tenth embodiment.

In L1-RSRP measurement, a UE may apply either a scheme with beam prediction or a fallback scheme. Hereinafter, a “scheme to be applied” may be one of the scheme with beam prediction and the fallback scheme, and a “scheme to be configured” may be at least one of the scheme with beam prediction and the fallback scheme.

The bit width of the field for the L1-RSRP-related report (CSI report) may be determined, for example, in accordance with at least one of Options 10-1 to 10-3 below.

### {Option 10-1}

The bit width of the field for the L1-RSRP-related report may be determined based on the number of candidate RS resources to be reported associated with a scheme to be applied.

The UE may determine the bit width of the field for the L1-RSRP-related report, based on the number of candidate RS resources to be reported associated with a scheme to be applied.

### {Option 10-2}

The bit width of the field for the L1-RSRP-related report may be determined based on a maximum number of candidate RS resources to be reported in all the schemes to be configured.

The UE may determine the bit width of the field for the L1-RSRP-related report, based on a maximum number of candidate RS resources to be reported in all the schemes to be configured.

According to Option 10-2, it is possible to efficiently operate without changing a bit width for schemes.

According to Option 10-2, it is possible to efficiently operate without changing a bit width by switching/applying an AI model.

According to Option 10-2, it is possible to perform communication with high reliability even when a case of a discrepancy in signal recognitions between the UE and the network (base station) occurs.

### {Option 10-3}

The bit width of the field for the L1-RSRP-related report may be determined based on a maximum number of candidate RS resources to be reported in some sets of schemes to be configured.

The UE may determine the bit width of the field for the L1-RSRP-related report, based on a maximum number of candidate RS resources to be reported in some sets of schemes to be configured.

The set of schemes to be configured may be notified to the UE by using at least one piece of information described in Supplement 2 below.

According to Option 10-3, it is possible to efficiently operate without changing a bit width for schemes.

According to Option 10-3, it is possible to efficiently operate without changing a bit width by switching/applying an AI model.

According to Option 10-3, it is possible to perform communication with high reliability even when a case of a discrepancy in signal recognitions between the UE and the network (base station) occurs.

According to the tenth embodiment above, it is possible to appropriately determine a bit width of a field for an L1-RSRP-related report (CSI report) even when fallback/switching operation is defined.

### <Variations of Application to Time-domain (Temporal) Beam Prediction>

The first to tenth embodiments above may be applied to spatial-domain beam prediction.

At least one of the first to tenth embodiments above may be applied to time-domain beam prediction.

At least one of the first to tenth embodiments above may be applied to a combination of spatial-domain beam prediction and time-domain beam prediction.

Predicted channel quality/beam quality may be channel quality/beam quality in a time instance (for example, symbol/slot/subframe/ms) different from that of a measured value.

The UE may determine a CRI/SSBRI, based on an L1-RSRP predicted in the future. Subsequently, the UE may report the L1-RSRP predicted in the future.

The UE may determine a CRI/SSBRI, based on an L1-RSRP predicted in the future. Subsequently, the UE may report a measured value as an L1-RSRP without performing beam prediction.

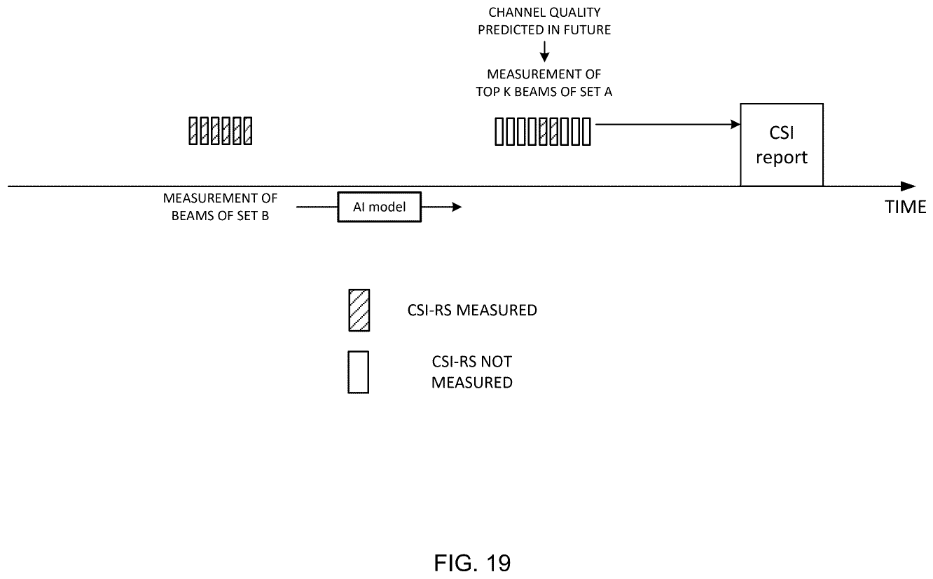

FIG. 19 is a diagram to show an example of the time-domain beam prediction. The example shown in FIG. 19 shows an example in which two-stage beam measurement is applied to the time-domain beam prediction.

In the example shown in FIG. 19, a predicted beam indicates channel quality in the future different from that in a time instance in first measurement.

The UE may report a predicted L1-RSRP in a time instance different from a time instance of a measured L1-RSRP.

As a fallback scheme, the UE may report a measured L1-RSRP.

For example, when the UE applies (only) time-domain (temporal) beam prediction, as a fallback scheme, the UE may report a measured L1-RSRP.

For example, the UE may measure RS resources used for beam prediction before a fallback, and may report some or all of the measured L1-RSRPs.

The UE may report predicted L1-RSRPs in different RS resources in a time instance different from that for an RS resource in a time instance of a measured L1-RSRP.

As a fallback scheme, the UE may report a measured L1-RSRP.

For example, when the UE applies time-domain (temporal) beam prediction and spatial-domain beam prediction, as a fallback scheme, the UE may report a measured L1-RSRP.

For example, the UE may measure RS resources used for beam prediction before a fallback, and may report some or all of the measured L1-RSRPs. The UE may determine that both of the time-domain (temporal) beam prediction and the spatial-domain beam prediction are disabled.

For example, the UE may measure RS resources, and may report predicted L1-RSRPs of RS resources measured in different time instances. The UE may determine that (only) the time-domain (temporal) beam prediction is enabled.

The different time instances may be the same time instances as a time instance associated with an L1-RSRP reported before a fallback.

The different time instances may be time instances configured/indicated for the fallback.

For example, the UE may measure RS resources, and may report predicted L1-RSRPs of (RS resources including) RS resources different from the measured RS resources. The UE may determine that (only) the spatial-domain beam prediction is enabled.

The different RS resources may be RS resources reported before the fallback.

The RS resources may be RS resources configured/indicated for the fallback.

According to the present embodiment above, it is possible to appropriately apply each of the embodiments of the present disclosure to time-domain (temporal) beam prediction and spatial-domain beam prediction.

### <Supplement>

### {AI Model Information (Supplement 1)}

In the present disclosure, AI model information may refer to information including at least one of the following:
information of an input/output of an AI model,
information of pre-processing/post-processing for an input/output of an AI model,
information of parameters of an AI model,
training information for an AI model,
inference information for an AI model, and
performance information related to an AI model.

Here, the information of an input/output of AI model may refer to information including at least one of the following:
Contents of input/output data (for example, RSRP, SINR, amplitude/phase information in a channel matrix (or precoding matrix), information related to an angle of arrival (AoA), information related to an angle of departure (AoD), location information),
auxiliary information of data (which may be referred to as meta information),
a type of input/output data (for example, an immutable value, a floating-point value),
a bit width of input/output data (for example, 64 bits for each input value),
a quantization interval of input/output data (a quantization step size) (for example, 1 dBm for L 1-RSRP), and
a possible range of input/output data (for example, [0, 1]).

Note that in the present disclosure, the information related to the AoA may include information related to at least one of an azimuth angle of arrival and a zenith angle of arrival (ZoA). The information related to the AoD may include information related to at least one of, for example, an azimuth angle of departure and a zenith angle of departure (ZoD).

In the present disclosure, the location information may be location information related to the UE/NW. The location information may include at least one of information (for example, a latitude, a longitude, or an altitude) obtained by using a positioning system (for example, satellite positioning system (such as Global Navigation Satellite System (GNSS) and Global Positioning System (GPS)), information of a BS adjacent to the UE (or a serving BS) (for example, an identifier (ID) of the BS/cell, a distance between the BS and the UE, a direction/angle of the BS (UE) when viewed from the UE (BS), coordinates of the BS (UE) when viewed from the UE (BS) (for example, the X/Y/Z-axis coordinates) or the like), a specific address (for example, an Internet Protocol (IP) address) of the UE, and the like. The location information of the UE is not limited to information with reference to the position of the BS and may be information with reference to a specific point.

The location information may include information related to the implementation of the UE itself (for example, the location (position)/direction of an antenna, the location/direction of an antenna panel, the number of antennas, the number of antenna panels, or the like).

The location information may include mobility information.

The mobility information may include information indicating at least one of information indicating a mobility type, a moving speed of the UE, an acceleration of the UE, a moving direction of the UE, and the like.

Here, the mobility type may correspond to at least one of fixed location UE, movable/moving UE, no mobility UE, low mobility UE, middle mobility UE, high mobility UE, cell-edge UE, not-cell-edge UE, and the like.

In the present disclosure, environment information (for data) may be information related to an environment in which the data is acquired/used, and may correspond to, for example, frequency information (such as a band ID), environment type information (information indicating at least one of indoor, outdoor, Urban Macro (UMa), Urban Micro (Umi), and the like), information indicating Line Of Site (LOS)/Non-Line Of Site (NLOS), and the like.

Here, LOS may mean that the UE and the BS are in an environment where they can see each other (or there is no shield), and NLOS may mean that the UE and the BS are not in an environment where they can see each other (or there is a shield). The information indicating LOS/NLOS may indicate a soft value (for example, probability of LOS/NLOS) or a hard value (for example, either of LOS/NLOS).

In the present disclosure, the meta information may mean, for example, information related to input/output information suitable for an AI model, information related to acquired/available data, or the like. Specifically, the meta information may include information related to a beam of an RS (for example, a CSI-RS/SRS/SSB or the like) (for example, an angle of a direction of each beam, a 3 dB beam width, a shape of a directed beam, the number of beams), qNB/UE antenna layout information, frequency information, environment information, a meta information ID, and the like. Note that the meta information may be used as an input/output of an AI model.

The information of pre-processing/post-processing for an input/output of an AI model described above may include information related to at least one of the following:
whether to apply normalization (for example, Z score normalization (standardization), minimum-maximum (min-max) normalization),
parameters for normalization (for example, a mean/variance for Z score normalization, a minimum/maximum value for min-max normalization),
whether to apply a specific numerical inversion method (for example, one hot encoding, label encoding, and the like), and
a selection rule whether to be used as training data.

For example, the Z score normalization as the pre-processing may be performed on input information x to obtain normalized input information X_{new} (X_{new}=(x−μ)/σ, where μ represents a mean of x, σ represents a standard deviation) and the obtained normalized input information X_{new} may be input to an AI model, and the post-processing may be performed on an output yₒᵤₜ from the AI model to obtain a final output y.

The information of parameters of an AI model described above may include information related to at least one of the following:
weight (for example, a coefficient (coupling coefficient) of a neuron) information in an AI model,
a structure of an AI model,
a type of an AI model as a model component (for example, Residual Network (ResNet), DenseNet, RefineNet, a transformer model, CRBlock, a recurrent neural network (RNN), a long short-term memory (LSTM), a gated recurrent unit (GRU)), and
a function of an AI model as a model component (for example, decoder, encoder).

Note that the weight information in an AI model may include information related to at least one of the following:
a bit width (size) of the weight information,
a quantization interval of the weight information,
granularity of the weight information,
a possible range of the weight information,
parameters of a weight in an AI model,
information of a difference from a pre-updated AI model (in a case of updating) and,
a weight initialization method (for example, zero-initialization, random initialization (based on normal distribution/uniform distribution/truncated normal distribution), Xavier initialization (for sigmoid function), He initialization (for rectified linear units (ReLU)).

The structure of an AI model described above may include information related to at least one of the following:
the number of layers,
a type of a layer (for example, a convolutional layer, an activation layer, a dense layer, a normalization layer, a pooling layer, an attention layer),
layer information,
time series-specific parameters (for example, bidirectionality, time step), and
parameters of training (for example, a type of a function (L2 regularization, dropout function, and the like), where to arrange this function (for example, after which layer)).

The layer information may include information related to at least one of the following:
the number of neurons in each layer.
a kernel size,
a stride for pooling layer/convolutional layer,
a pooling method (MaxPooling, AveragePooling, and the like),
information of a residual block,
the number of heads,
a normalization method (batch normalization, instance normalization, layer normalization, and the like), and
an activation function (sigmoid, tanh function, ReLU, leaky ReLU information, Maxout, Softmax).

A certain AI model may be included as a component of another AI model. For example, the certain AI model may be an AI model in which processing proceeds from a ResNet that is model component #1 to a transformer model that is model component #2 to a dense layer to a normalization layer.

Training information for the above AI model may include information related to at least one of the following:
information for an optimization algorithm (for example, a kind of optimization (stochastic gradient descent (SGD)), AdaGrad, Adam, and the like), parameters for optimization (learning rate, momentum information, and the like),
information of a loss function (for example, information related to a loss function indexes (metrics) (mean absolute error (MAE)), mean square error (MSE), a cross-entropy loss, NLLLoss, Kullback-Leibler (KL) divergence, and the like),
parameters to be frozen for training (for example, a layer, a weight),
parameters to be updated (for example, a layer, a weight) ,
parameters to be initial parameters (to be used as initial parameters) for training (for example, a layer, a weight), and
a method of training/updating an AI model (for example, the (recommended) number of epochs, a batch size, the number of pieces of data used for training).

The inference information for an AI model described above may include information related to decision tree branch pruning, parameter quantization, an AI model function, and the like. Here, the AI model function may correspond to, for example, at least one of time-domain beam prediction, spatial-domain beam prediction, an autoencoder for CSI feedback, an autoencoder for beam management, and the like.

The autoencoder for CSI feedback may be used as follows:
the UE transmits, as CSI feedback (CSI report), an encoded bit output by inputting CSI/channel matrix/precoding matrix to an AI model of an encoder, and
the BS reconstructs the CSI/channel matrix/precoding matrix output by inputting the received encoded bit to an AI model of a decoder.

In spatial-domain beam prediction, the UE/BS may input, to the AI model, a measurement result (beam quality, for example, RSRP) based on a sparse (or thick) beam to output dense (or thin) beam quality.

In time-domain beam prediction, the UE/BS may input, to the AI model, a time-series (past, current, or the like) measurement result (beam quality, for example, RSRP) to output future beam quality.

The performance information related to an AI model described above may include information related to an expected value of a loss function defined for the AI model.

The AI model information in the present disclosure may include information related to a range of application (applicable range) of an AI model. The range of the application may be indicated by a physical cell ID, a serving cell index, or the like. The above-described environment information may include information related to the range of the application.

The AI model information related to a specific AI model may be predefined in a standard, or the UE may be notified of the AI model information from a network (NW). The AI model defined in a standard may be referred to as a reference AI model. The AI model information related to the reference AI model may be referred to as reference AI model information.

Note that the AI model information in the present disclosure may include an index for specifying an AI model (which may be referred to as an AI model index, an AI model ID, a model ID, and the like, for example). The AI model information in the present disclosure may include the AI model index in addition to/instead of the information of an input/output of an AI model described above. Association of the AI model index with the AI model information (for example, the information of an input/output of an AI model) may be predefined in a standard, or the UE may be notified of the association from the NW.

The AI model information in the present disclosure may be associated with an AI model, and may be referred to as AI model relevant information, relevant information simply, and so on. The AI model relevant information may not explicitly include information for specifying an AI model. The AI model relevant information may be, for example, information including only meta information.

### {Notification of Information to UE (Supplement 2)}

Any notification of information (from a NW) to a UE (in other words, any reception, in a UE, of information from a BS) in the above-described embodiments may be performed by using physical layer signaling (for example, DCI), higher layer signaling (for example, RRC signaling, a MAC CE), a specific signal/channel (for example, a PDCCH, a PDSCH, a reference signal), or combinations of these.

In a case where the notification described above is performed by the MAC CE, the MAC CE may be identified by a new logical channel ID (LCID) being included in a MAC sub-header, the new logical channel ID being not defined in an existing specification.

In a case where the notification described above is performed by the DCI, the notification described above may be performed by use of a specific field of the DCI, a radio network temporary identifier (RNTI) used to scramble a cyclic redundancy check (CRC) bit attached to the DCI, a format of the DCI, and the like.

Any notification of information to a UE in the above-described embodiments may be performed periodically, semi-persistently, or aperiodically.

{Notification of Information from UE (Supplement 3)}

Any notification of information from a UE (to a NW) (in other words, any transmission, in a UE, of information to a BS) in the above-described embodiments may be performed by using physical layer signaling (for example, UCI), higher layer signaling (for example, RRC signaling, a MAC CE), a specific signal/channel (for example, a PUCCH, a PUSCH, a reference signal), or combinations of these.

In a case where the notification described above is performed by the MAC CE, the MAC CE may be identified by a new LCID being included in a MAC sub-header, the new LCID being not defined in an existing specification.

In a case where the notification described above is performed by the UCI, the notification described above may be transmitted by using a PUCCH or a PUSCH.

Any notification of information from a UE in the above-described embodiments may be performed periodically, semi-persistently, or aperiodically.

### {Application of Respective Embodiments (Supplement 4)}

At least one of the above-described embodiments may be applied to a case where a specific condition is satisfied. The specific condition may be defined in a specification, or may be notified to the UE/BS by using higher layer signaling/physical layer signaling.

At least one of the above-described embodiments may be applied only to a UE that has reported specific UE capabilities or that supports the specific UE capabilities.

The specific UE capabilities may indicate at least one of the following:
supporting specific processing/operation/control/information for at least one of the above-described embodiments/options,
supporting specific processing/operation/control/information for a combination of at least two of the above-described embodiments/options, and
determination of the reference symbol (in the sixth embodiment).

The specific UE capabilities described above may be a capability applied across all the frequencies (commonly regardless of frequency), a capability per frequency (for example, one or combinations of a cell, a band, a BWP, a band combination, a component carrier, and the like), a capability per frequency range (for example, Frequency Range 1 (FR1), FR2, FR3, FR4, FR5, FR2-1, FR2-2), or a capability per subcarrier spacing (SCS).

The specific UE capabilities described above may be a capability applied across all duplex modes (commonly regardless of duplex mode), or a capability per duplex mode (for example, time division duplex (TDD), frequency division duplex (FDD)).

At least one of the above-described embodiments may be applied to a case where specific information associated with the above-described embodiments (or operation for the above-described embodiments) is configured/activated/triggered for the UE by higher layer signaling/physical layer signaling. For example, the specific information may be information indicating enabling of a use of an AI model, any RRC parameter for a specific release (for example, Rel. 18), or the like.

In a case where the UE does not support at least one of the specific UE capabilities described above or is not configured with the specific information, the UE may apply, for example, Rel-15/16 operation.

### (Supplementary Notes A)

Regarding one embodiment of the present disclosure, the following supplementary notes of the invention will be given.

### {Supplementary Note A-1}

A terminal including:
a receiving section that receives a configuration of a first set related to measurement of a reference signal and a configuration of a second set related to reporting of a reference signal; and
a control section that controls prediction of a result of measurement of a second reference signal resource included in the second set and reporting of the predicted result of the measurement, based on measurement of a first reference signal resource included in the first set.

### {Supplementary Note A-2}

The terminal according to supplementary note A-1, wherein the second reference signal resource includes a resource different from the first reference signal resource.

### {Supplementary Note A-3}

The terminal according to supplementary note A-1 or A-2, wherein the second reference signal resource includes the first reference signal resource.

### {Supplementary Note A-4}

The terminal according to any one of supplementary notes A-1 to A-3, wherein a bit width of a reference signal resource indicator corresponding to the predicted result of the measurement is determined based on the number of at least one of the first reference signal resources and the second reference signal resources.

### (Supplementary Notes B)

Regarding one embodiment of the present disclosure, the following supplementary notes of the invention will be given.

### {Supplementary Note B-1}

A terminal including:
a receiving section that receives a configuration of a first set related to measurement of a reference signal and a configuration of a second set related to reporting of a reference signal; and
a control section that performs prediction of a result of measurement of a second reference signal resource included in the second set, based on first measurement of a first reference signal resource included in the first set, performs second measurement of at least one of the second reference signal resources, based on the prediction, and performs reporting of a measurement result based on the second measurement.

### {Supplementary Note B-2}

The terminal according to supplementary note B-1, wherein the second reference signal resource includes a resource different from the first reference signal resource.

### {Supplementary Note B-3}

The terminal according to supplementary note B-1 or B-2, wherein the control section determines the number of the second reference signal resources with the second measurement, based on configuration related to a maximum number of the second reference signal resources with the second measurement.

### {Supplementary Note B-4}

The terminal according to any one of supplementary notes B-1 to B-3, wherein a bit width of a reference signal resource indicator corresponding to the reported measurement result is determined based on the number of at least one of the first reference signal resources and the second reference signal resources.

### (Supplementary Notes C)

Regarding one embodiment of the present disclosure, the following supplementary notes of the invention will be given.

### {Supplementary Note C-1}

A terminal including:
a receiving section that receives a physical downlink control channel (PDCCH) for triggering a channel state information report, a first reference signal, and a second reference signal; and
a control section that performs prediction related to the second reference signal and based on measurement of the first reference signal, based on a reception timing of the first reference signal and a reception timing of the second reference signal.

### {Supplementary Note C-2}

The terminal according to supplementary note C-1, wherein a last symbol for the first reference signal is located a specific period or more before a first symbol for the second reference signal.

### {Supplementary Note C-3}

The terminal according to supplementary note C-1 or C-2, wherein the control section determines whether the channel state information report is enabled, based on at least two of a reception timing of the PDCCH, a reception timing of the first reference signal, a reception timing of the second reference signal, and a timing of the channel state information report.

### {Supplementary Note C-4}

The terminal according to any one of supplementary notes C-1 to C-3, wherein the control section determines whether the channel state information report is enabled, based on at least one of a first period from a last symbol for the PDCCH until a first symbol for the channel state information report, a second period from a last symbol for the first reference signal until the first symbol for the channel state information report, and a third period from a last symbol for the second reference signal until the first symbol for the channel state information report.

### (Supplementary Notes D)

Regarding one embodiment of the present disclosure, the following supplementary notes of the invention will be given.

### {Supplementary Note D-1}

A terminal including:
a control section that controls, based on a specific condition, switching between a first method in which a reference signal to be reported is included in a reference signal to be measured, and a second method in which the reference signal to be reported is not included in the reference signal to be measured; and
a transmitting section that performs a channel state information report, based on the first method or the second method.

### {Supplementary Note D-2}

The terminal according to supplementary note D-1, wherein the first method does not include prediction of a measurement result based on measurement of a reference signal.

{Supplementary Note D-3} The terminal according to supplementary note D-1 or D-2, wherein the specific condition is a condition based on performance monitoring.

### {Supplementary Note D-4}

The terminal according to any one of supplementary notes D-1 to D-3, wherein the control section determines a bit width of a field included in the channel state information report, based on one of application of the first method and application of the second method, or at least one of configuration of the first method and configuration of the second method.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

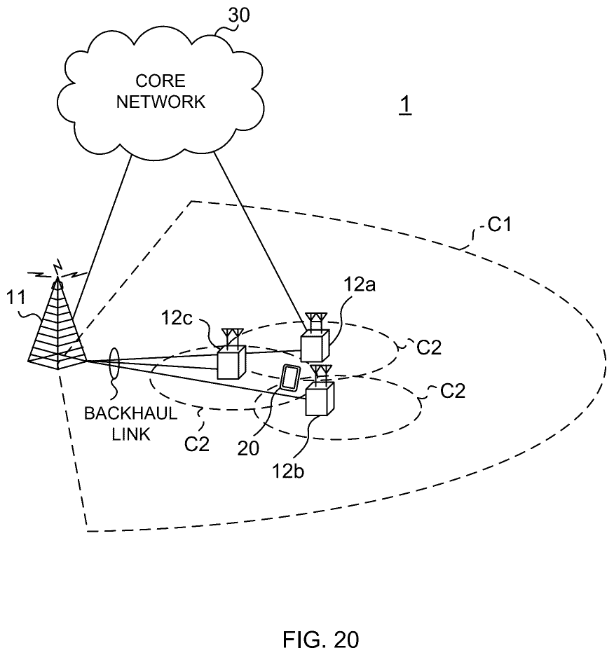

FIG. 20 is a diagram to show an example of a schematic structure of the radio communication system according to one embodiment. The radio communication system 1 (which may be simply referred to as a system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHZ or less (sub-6 GHZ), and FR 2 may be a frequency band which is higher than 24 GHZ (above −24 GHZ). Note that frequency bands, definitions and so on of FRI and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.” The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include network functions (NF) such as a User Plane Function (UPF), an Access and Mobility management Function (AMF), a Session Management Function (SMF), Unified Data Management (UDM), an ApplicationFunction (AF), a Data Network (DN), a Location Management Function (LMF), and operation, administration, and maintenance (Management) (OAM). Note that a plurality of functions may be provided by one network node.

Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data,” and the PUSCH may be interpreted as “UL data.”

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a reference signal for measurement (Sounding Reference Signal (SRS)), a demodulation reference signal (DMRS), and so on may be communicated as an uplink reference signal (UL-RS). Note that DMRS may be referred to as a “user terminal specific reference signal (UE-specific Reference Signal).”

### (Base Station)

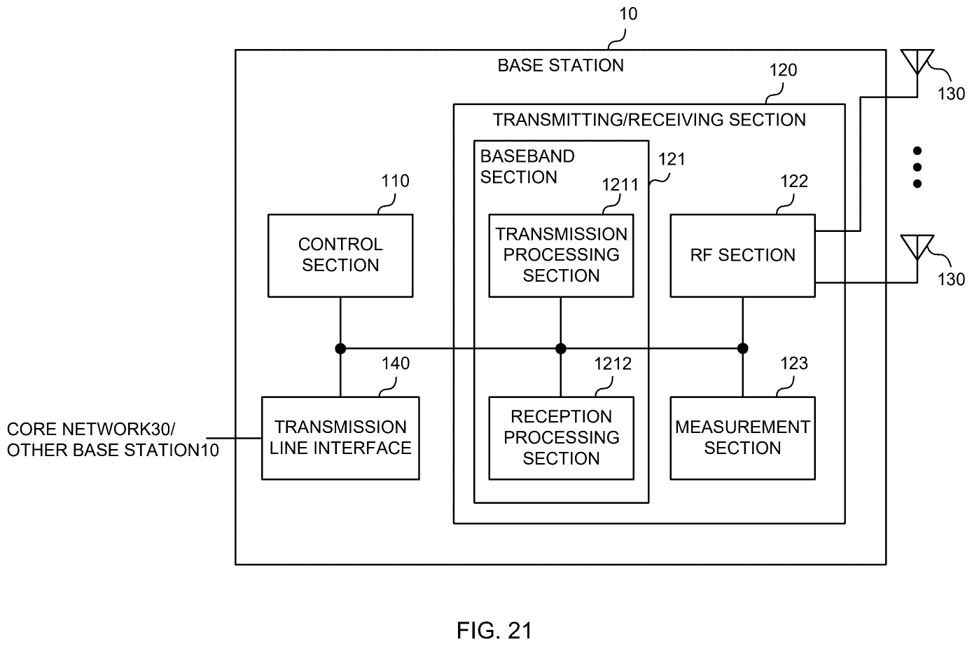

FIG. 21 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may transmit/receive (perform backhaul signaling of) a signal with an apparatus (for example, a network node providing NFs) included in the core network 30 or other base stations 10, and so on, and may acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit a configuration of a first set (set B) related to measurement of a reference signal and a configuration of a second set (set A) related to reporting of a reference signal. The control section 110 may control reception of a result of measurement of a second reference signal resource included in the second set, the result being predicted based on measurement of a first reference signal resource included in the first set (first embodiment).

The transmitting/receiving section 120 may transmit a configuration of a first set related to measurement of a reference signal and a configuration of a second set related to reporting of a reference signal. The control section 110 may indicate prediction of a result of measurement of a second reference signal resource included in the second set, the prediction being based on first measurement of a first reference signal resource included in the first set, may indicate second measurement of at least one of the second reference signal resources, the second measurement being based on the prediction, and may control reception of a report of a measurement result based on the second measurement (fourth embodiment).

The transmitting/receiving section 120 may transmit a physical downlink control channel (PDCCH) for triggering a channel state information report, a first reference signal, and a second reference signal. The control section 110 may indicate prediction related to the second reference signal and based on measurement of the first reference signal by using a reception timing of the first reference signal and a reception timing of the second reference signal (seventh embodiment).

The control section 110 may indicate, by using a specific condition, switching between a first method (for example, a fallback scheme) in which a reference signal to be reported is included in a reference signal to be measured, and a second method in which the reference signal to be reported is not included in the reference signal to be measured. The transmitting/receiving section 120 may receive a channel state information report transmitted based on the first method or the second method (ninth embodiment).

### (User Terminal)

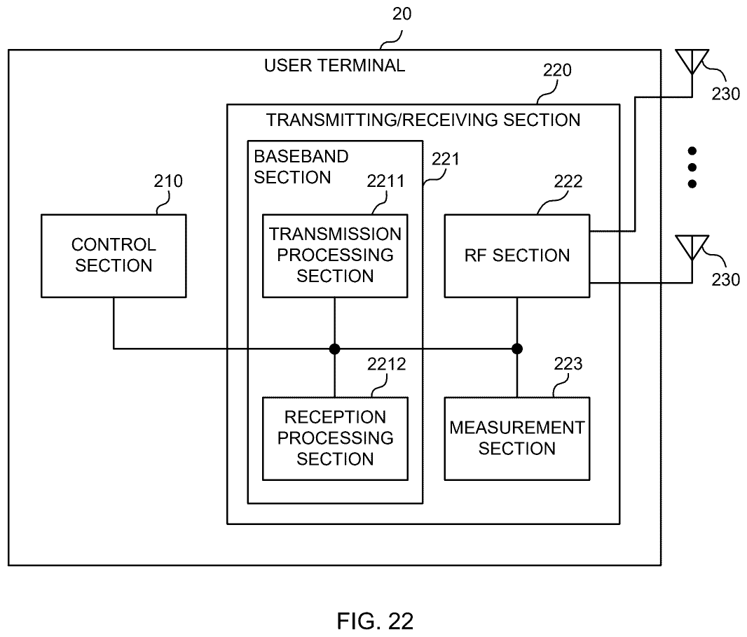

FIG. 22 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223.

The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section.

The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive a configuration of a first set (set B) related to measurement of a reference signal and a configuration of a second set (set A) related to reporting of a reference signal (first embodiment).

The control section 210 may control prediction of a result of measurement of a second reference signal resource included in the second set and reporting of the predicted result of the measurement, based on measurement of a first reference signal resource included in the first set (first embodiment).

The second reference signal resource may include a resource different from the first reference signal resource (first/second embodiment).

The second reference signal resource may include the first reference signal resource (second embodiment).

A bit width of a reference signal resource indicator corresponding to the predicted result of the measurement may be determined based on the number of at least one of the first reference signal resources and the second reference signal resources (third embodiment).

The transmitting/receiving section 220 may receive a configuration of a first set related to measurement of a reference signal and a configuration of a second set related to reporting of a reference signal. The control section 210 may perform prediction of a result of measurement of a second reference signal resource included in the second set, based on first measurement of a first reference signal resource included in the first set, may perform second measurement of at least one of the second reference signal resources, based on the prediction, and may perform reporting of a measurement result based on the second measurement (fourth embodiment).

The second reference signal resource may include a resource different from the first reference signal resource (fourth/fifth embodiment).

The control section 210 may determine the number of the second reference signal resources with the second measurement, based on configuration related to a maximum number of the second reference signal resources with the second measurement (fourth embodiment).

A bit width of a reference signal resource indicator corresponding to the reported measurement result may be determined based on the number of at least one of the first reference signal resources and the second reference signal resources (sixth embodiment).

The transmitting/receiving section 220 may receive a physical downlink control channel (PDCCH) for triggering a channel state information report, a first reference signal, and a second reference signal. The control section 210 may perform prediction related to the second reference signal and based on measurement of the first reference signal, based on a reception timing of the first reference signal and a reception timing of the second reference signal (seventh embodiment).

A last symbol for the first reference signal may be located a specific period or more before a first symbol for the second reference signal (seventh embodiment).

The control section 210 may determine whether the channel state information report is enabled, based on at least two of a reception timing of the PDCCH, a reception timing of the first reference signal, a reception timing of the second reference signal, and a timing of the channel state information report (eighth embodiment).

The control section 210 may determine whether the channel state information report is enabled, based on at least one of a first period from a last symbol for the PDCCH until a first symbol for the channel state information report, a second period from a last symbol for the first reference signal until the first symbol for the channel state information report, and a third period from a last symbol for the second reference signal until the first symbol for the channel state information report (eighth embodiment).

The control section 210 may control, based on a specific condition, switching (fallback) between a first method in which a reference signal to be reported is included in a reference signal to be measured, and a second method in which the reference signal to be reported is not included in the reference signal to be measured. The transmitting/receiving section 220 may perform a channel state information report, based on the first method or the second method (ninth embodiment).

The first method may not include prediction of a measurement result based on measurement of a reference signal (ninth embodiment).

The specific condition may be a condition based on performance monitoring (ninth embodiment).

The control section 210 may determine a bit width of a field included in the channel state information report, based on one of application of the first method and application of the second method, or at least one of configuration of the first method and configuration of the second method (tenth embodiment).

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

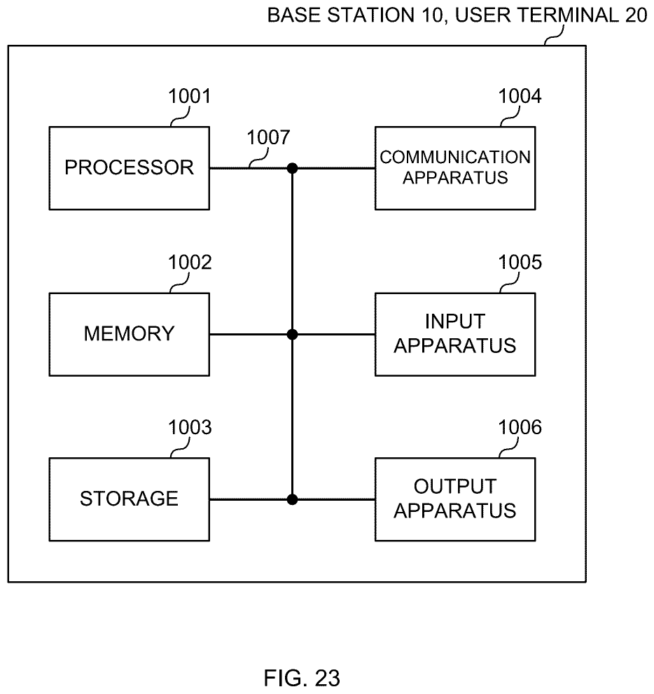

For example, a base station, a user terminal, and so on according to one embodiment of the present disclosure may function as a computer that executes the processes of the radio communication method of the present disclosure. FIG. 23 is a diagram to show an example of a hardware structure of the base station and the user terminal according to one embodiment.

Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform computations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used.

For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies.

Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIS.

Note that, in the case where one slot or one mini-slot is referred to as a TTI, one or more TTIS (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP.” Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input/output may be stored in a specific location (for example, a memory) or may be managed by using a management table. The information, signals, and so on to be input/output can be overwritten, updated, or appended. The information, signals, and so on that are output may be deleted. The information, signals, and so on that are input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be notified using, for example, MAC control elements (MAC CES).

Also, notification of certain information (for example, notification of “X holds”) does not necessarily have to be notified explicitly, and can be notified implicitly (by, for example, not performing notification of this certain information or performing notification of another piece of information).

Determinations may be made in values represented by one bit (0 or 1), may be made in Boolean values that represent true or false, or may be made by comparing numerical values (for example, comparison against a certain value) .

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs)) ). The term “cell” or “sector” refers to part of or the entire coverage area of at least one of a base station and a base station subsystem that provides communication services within this coverage.

In the present disclosure, a base station transmitting information to a terminal may be interchangeably interpreted as the base station indicate control/operation base on the information to the terminal.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type).

Note that at least one of a base station and a mobile station also includes an apparatus which does not necessarily move during communication operation. For example, at least one of a base station and a mobile station may be an Internet of Things (IoT) device such as a sensor.

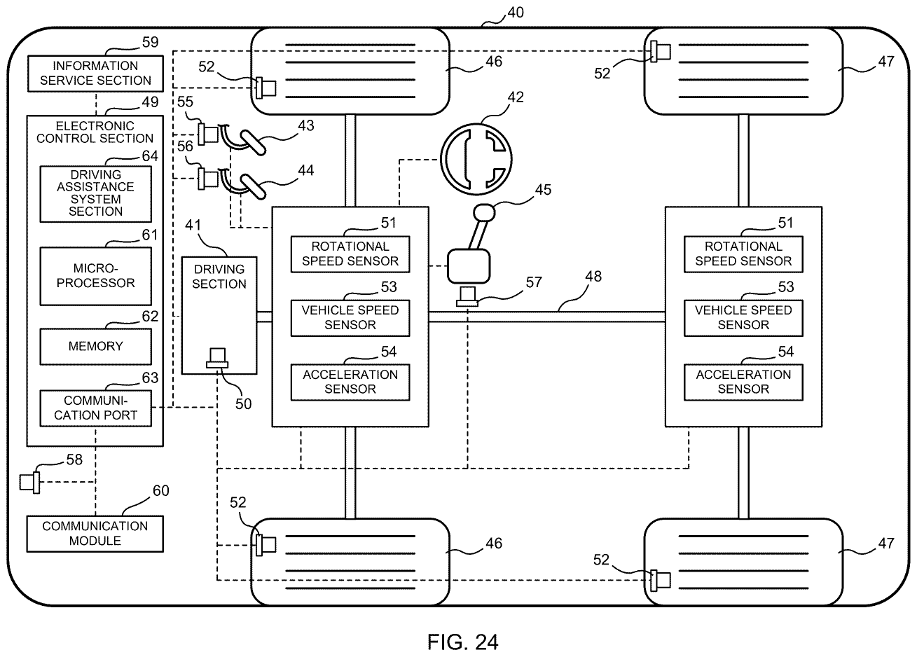

FIG. 24 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (10) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUS that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle.

The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG, where x is, for example, an integer or a decimal), Future Radio Access (FRA) , New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory) , and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.” In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B are each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

In the present disclosure, “equal to or less than,” “less than,” “more than,” “equal to,” and the like may be interchangeably interpreted. In the present disclosure, the words meaning “good,” “bad,” “large,” “small,” “high,” “low,” “early,” “late,” and the like may be interchangeably interpreted (without distinction of positive, comparative, superlative). In the present disclosure, the words meaning “good,” “bad,” “large,” “small,” “high,” “low,” “early,” “late,” and the like may be interchangeably interpreted as expressions of those with “ith” prefixed (without distinction of positive, comparative, superlative) (for example, “highest” may be interchangeably interpreted as “ith highest”).

In the present disclosure, “of,” “for,” “regarding,” “related to,” “associated with,” and the like may be interchangeably interpreted.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1.-6. (canceled)

7. A terminal comprising:
a receiver that receives a configuration of a first set of Synchronization Signal/Physical Broadcast Channel (SS/PBCH) block resources for measurement, a configuration of a second set of SS/PBCH block resources for prediction and reporting, and a report quantity parameter included in a Channel State Information (CSI) report configuration; and
a processor that, when a parameter for calculating predicted Layer 1 Reference Signal Received Power (L1-RSRP) using an SS/PBCH block is set in the report quantity parameter, controls, based on measurement of SS/PBCH block resources configured by the configuration of the first set, a report of predicted L1-RSRP in SS/PBCH block resources configured by the configuration of the second set,
wherein a bit width of a field for reporting an SS/PBCH block resource indicator included in the report of the predicted L1-RSRP is determined based on a number of SS/PBCH blocks corresponding to the second set.

8. A radio communication method for a terminal, comprising:
receiving a configuration of a first set of Synchronization Signal/Physical Broadcast Channel (SS/PBCH) block resources for measurement, a configuration of a second set of SS/PBCH block resources for prediction and reporting, and a report quantity parameter included in a Channel State Information (CSI) report configuration; and
when a parameter for calculating predicted Layer 1 Reference Signal Received Power (L1-RSRP) using an SS/PBCH block is set in the report quantity parameter, controlling, based on measurement of SS/PBCH block resources configured by the configuration of the first set, a report of predicted L1-RSRP in SS/PBCH block resources configured by the configuration of the second set,
wherein a bit width of a field for reporting an SS/PBCH block resource indicator included in the report of the predicted L1-RSRP is determined based on a number of SS/PBCH blocks corresponding to the second set.

9. A base station comprising:
a transmitter that transmits a configuration of a first set of Synchronization Signal/Physical Broadcast Channel (SS/PBCH) block resources for measurement, a configuration of a second set of SS/PBCH block resources for prediction and reporting, and a report quantity parameter included in a Channel State Information (CSI) report configuration; and
a processor that, when a parameter for calculating predicted Layer 1 Reference Signal Received Power (L1-RSRP) using an SS/PBCH block is set in the report quantity parameter, controls reception of a report of predicted L1-RSRP in SS/PBCH block resources configured by the configuration of the second set, the predicted L1-RSRP being predicted based on measurement of SS/PBCH block resources configured by the configuration of the first set,
wherein a bit width of a field for reporting an SS/PBCH block resource indicator included in the report of the predicted L1-RSRP is determined based on a number of SS/PBCH blocks corresponding to the second set.

10. A system comprising: a base station; and a terminal, the base station comprising:
a transmitter that transmits a configuration of a first set of Synchronization Signal/Physical Broadcast Channel (SS/PBCH) block resources for measurement, a configuration of a second set of SS/PBCH block resources for prediction and reporting, and a report quantity parameter included in a Channel State Information (CSI) report configuration, and
the terminal comprising:
a receiver that receives the configuration of the first set, the configuration of the second set, and the report quantity parameter; and
a processor that, when a parameter for calculating predicted Layer 1 Reference Signal Received Power (L1-RSRP) using an SS/PBCH block is set in the report quantity parameter, controls, based on measurement of SS/PBCH block resources configured by the configuration of the first set, a report of predicted L1-RSRP in SS/PBCH block resources configured by the configuration of the second set,
wherein a bit width of a field for reporting an SS/PBCH block resource indicator included in the report of the predicted L1-RSRP is determined based on a number of SS/PBCH blocks corresponding to the second set.
